(19) United States
(12) Patent Application Publication
(10) Pub. No.: US 2017/0332676 A1
(43) Pub. Date: Nov. 23, 2017

(54) Dynamic Power Management System, Method And Temperature Control For Conditioners

(71) Applicant: Innit International S.C.A., Luxembourg (LU)

(72) Inventors: Eugenio Minvielle, Hillsborough, CA (US); Francisco X. Deolarte, Hillsborough, CA (US); Juan Jose Gonzalez, Tampa, FL (US)

(21) Appl. No.: 15/603,312

(22) Filed: May 23, 2017

Related U.S. Application Data
(60) Provisional application No. 62/340,471, filed on May 23, 2016.
(60) Provisional application No. 62/349,931, filed on Jun. 14, 2016.

(51) Int. Cl. A23L 5/10; A47J 27/00; A47J 37/01; G05D 23/19; A47J 37/06

(52) U.S. Cl. CPC A23L 5/10; G05D 23/1917; G05D 23/1904; A47J 37/0694; A47J 37/06; A47J 37/01; A47J 27/004; A23V 2002/00

(57) ABSTRACT

Disclosed is a conditioner to condition nutritional substances with conditioning programs that power conditioning elements for percentage of the time of a repeating temporal cycle. During each temporal cycle, each required conditioning element may be activated for only a percentage of the full time of the temporal cycle. The conditioner includes temperature controls that are responsive to sensor feedback from the conditioner and that modify the conditioning element activation during the cycles.

### CROSS REFERENCE TO RELATED APPLICATIONS

This application claims the benefit of, and priority to, U.S. Provisional Patent Application Ser. No. 62/340,471, filed May 23, 2016 and U.S. Provisional Patent Application Ser. No. 62/349,931 filed Jun. 14, 2016, the entire contents of both of which are hereby incorporated by reference.

### FIELD

Embodiments of the present invention generally relate to dynamic power management and temperature control systems and methods useful for conditioning or processing of nutritional substances. Embodiments of the present invention further enable flexible multi-step conditioning cycle creation and management.

### BACKGROUND

The following description includes information that may be useful in understanding the present invention. It is not an admission that any of the information provided herein is prior art or relevant to the presently claimed invention, or that any publication specifically or implicitly referenced is prior art.

Convectional conditioners (such as for example convection ovens) generally comprise a conditioning chamber or cavity, a combination of conditioning elements to condition or process the nutritional substance using, for example, electricity or gas, and sensors e.g. temperature and relative humidity sensors, to monitor and control the conditioning process of a nutritional substance. These conditioning elements are typically positioned at various places in the conditioner chamber and influence the conditioning process in a variety of ways. For example, a convection element may help to distribute heat more evenly and more efficiently for better temperature control inside the cavity, since circulating air transfers heats more efficiently. A broil, or overhead conditioning element, delivers intense radiant heat to condition the nutritional substance, producing temperatures upwards of 600° F. and promoting Maillard reaction (chemical reaction between amino acids and reducing sugars that gives browned nutritional substances their distinctive flavor) on the surface of the nutritional substance, imparting the browned and grilled taste. Baking transfers heat from the bottom of the cavity to the top, while natural and/or forced convection distributes heat throughout the cavity, ideal for conditioning pastries and other nutritional substances known as “baked goods”. While bake, convection and broil elements heat up the air in the cavity transferring heat from the air to the surface of the nutritional substance, and then through conduction/convection from the surface to the center of the nutritional substance; microwave or radiofrequency conditioning elements use radio waves at a specifically set frequency to agitate water molecules inside the nutritional substance. As these water molecules become increasingly agitated they begin to vibrate at the atomic level and generate heat, and thus condition the nutritional substance from within and without directly affecting the temperature of the air inside the conditioner cavity.

Accordingly, most conventional conditioners use one or more of the following settings/functions to engage various conditioning elements: (1) fast pre-heat, (2) baking, (3) broiling, (4) microwave, (5) convection bake, (6) convection broil, or (7) convection roast and (8) others. To condition the nutritional substance, users generally must select one of these settings and select a target temperature (for the cavity or nutritional substance probe) and/or a target time—at this point the conditioner may activate one or more conditioning elements to implement one of these functions. Traditionally these functions are associated with only one or two specific conditioning elements (e.g. bake on the bottom, broil on the top); however, the definition of the conditioning function (such as bake, broil) varies arbitrarily, depending on the manufacturing brand and model, as the convection and true convection function is used more frequently in combination with the bake and/or broil conditioning elements. For instance, the convection bake function in model A from manufacturer 1, is programmed with 50% convection and 50% bake, whereas the convection bake function in model X from conditioning manufacturer 2 is defined as 70% bake and 30% convection. This definition of convection bake may even be different between two conditioner models assembled by the same manufacturer, as these two models might have differences in cavity size, conditioning element type and power, configuration, among other factors.

Most conventional conditioners are configured to heat up the cavity, also called preheat or preheating step, by turning on and off the conditioning elements as prescribed by the chosen conditioning setting or mode. To preheat the conditioner, the user can use one of the modes prescribed by the manufacturer, for instance, convection bake. In this case, one or more conditioning elements can stay on simultaneously, as long as the combined power output of these elements do not exceed the power input to the conditioner. If the combined output power of the conditioning elements is higher than the power input to the conditioner, then the conditioning elements can be alternated within fixed duration, repetitive cycles until the internal temperature (cavity or nutritional substance probe) reaches a target or set point temperature. Once the conditioner reaches the regulation step, i.e., it has reached the set point temperature prescribed by the user, the conditioner maintains the target temperature by continuously turning off the conditioning element(s) if the temperature sensor readout surpasses the set point temperature, and be turning on the conditioning element(s) if the temperature sensor readout is below a fixed number of degrees (as determined by the manufacturer) from the set point. In convection bake, for instance, there are at least two conditioning elements that alternate between on and off.

This control method used in most commercial conditioners is call bang-bang control. The bang-bang controller, also referred to as an on-off controller or hysteresis controller, is a feedback controller that switches abruptly between two states. These controllers may be realized in terms of any element that provides hysteresis. Most common residential thermostats are bang-bang controllers. This type of control method has limitations, for example there is a significant amount of temperature fluctuations (overshoot and undershoot) from the set point temperature when an off/on control scheme is used to regulate temperature and the limitations on the relays (e.g. mechanical) used by the controller to turn on and off the conditioning elements.

Furthermore, response time of the temperature sensor can impact the temperature fluctuations during the regulation step. If the conditioner has a temperature sensor with a long response time, the sensor readout reads lower than the actual temperature during the heat up cycle. By the time the temperature sensor readout reaches the target temperature, the actual temperature might be significantly higher, overshooting the actual temperature. Similarly, after the temperature overshoot, if the actual temperature goes below the set point, the sensor may still read higher than the set point, thus the temperature will undershoot until the temperature sensor readout goes below the set point temperature. In short, the degree of temperature fluctuations in the regulation step will be dependent on the type and power of the conditioning elements, the response time of the temperature and/or relative humidity sensors, size of cavity and type of nutritional substance, among other factors.

Generally, conventional conditioners only have options that allow for the activation of one or two conditioning elements simultaneously, and only allow the user to adjust the conditioning process using a fixed set of conditioning modes, such as internal temperature and relative humidity of the conditioner compartment, internal temperature of the nutritional substance, and time. In some conditioners, it is not possible to switch between conditioning modes, that is, if the user requires the use of additional conditioning modes within a conditioning program, the conditioner will have to be reset at the end of one conditioning mode and reconfigured to start the conditioner with a second conditioning mode. More advanced models of conditioners provide the user with some flexibility to program up to three consecutive conditioning modes; for instance, bake for 5 min at 275 degrees followed by convection roast for 20 min at 350 degrees and followed by convection broil for 2 min at 425 degrees, but that is all.

Conventional conditioners generally only have options or functions that condition nutritional substances using only one or two conditioning elements simultaneously. For instance, a user can only a mode that conditions with one or two conditioning element settings (e.g. bake or convection bake) and then sets a temperature and optionally a conditioning time. Once the target temperature and/or time is set and the conditioning process started by the user, the conditioner activates the one or two conditioning elements to heat the conditioner to the set target temperature. Current commercial conditioners utilize a bang-bang approach to control temperature, that is, the conditioning elements are switched off as the temperature rises above the upper limit of the control band and they are switched on as the temperature falls below the upper limit of the control band. This leads to significant over and undershooting of the temperature, which has an impact on the organoleptic properties of the nutritional substance.

In most commercially available conditioners, users cannot program sophisticated combinations of conditioning elements, or change the conditioning element combination during a conditioning session. In most cases, a user must reset the conditioner during conditioning if they wish to change the conditioner settings. In some advanced conditioners, some multi-programming is possible albeit limited and generally each step (made up of one or more repeating cycles) of the conditioning program is a combination of only one or two conditioning elements that are turned on and off simultaneously and the use of which does not exceed the maximum power available at a given time.

In electrical installation for conditioners for both commercial and households, the current, and thus power is limited for safety considerations, usually by a circuit breaker or fuse, which vary from 15 amps up to 40 amps in most locations. Assuming that a conditioner in a home is connected to 240 volts, 15 amps, the maximum power available would be 80% of 3600 watts, or 2880 watts. The available power consider for this illustration takes into account the current electrical safety regulations in the United States. Considering this limited amount of power, a combination of elements that is on during any one time must not exceed the 2880 watts. As mentioned previously, conventional conditioning elements can only be turned entirely on or entirely off—consuming the conditioning element's full required power, i.e., if the rated power of the conditioning element is 1800 watts at 240 volts, the power draw will be 1800 watts whenever the element is on. Therefore, the number or combination of elements that can be on simultaneously is limited, and is determined by each conditioning element's power requirements and the conditioner's maximum power available from its electrical installation. Accordingly, developing sophisticated conditioning programs that use two or more conditioning elements has been challenging and consequently has limited the sophistication of programs a conditioner may execute.

Some conventional conditioners have repeating cycles where—if two conditioning elements are used—the two conditioning elements may be activated in a staggered fashion so that while one conditioning element is on the other is off during repeating cycles (each cycle with a first conditioning element activated first and a second conditioning element activated second after the first is turned off and then repeated). In other cases, if turning both conditioning elements on at the same time does not exceed the maximum power, both conditioning elements may be activated at the same time. Assuming that the broil consumers 1800 watts, bake 1400 watts and convection 600, the following combinations are possible: broil by itself, bake by itself, convection by itself, broil and convection and bake and convection. It is not possible to turn on both broil and bake simultaneously, as the total power combined is 3200 watts, above the available current of 2880 watts.

As shown by the foregoing, there is a significant need for further advancements in power management and temperature control for conditioners. Moreover, such advancements are needed in order to enable better and more efficient means of conditioning or processing nutritional substances.

### SUMMARY

Disclosed herein are systems and methods that minimize conditioner power management inefficiencies and help to maximize conditioner cavity thermodynamics resulting in a significant reduction of conditioning time, better control of the conditioning process, higher residual nutritional content and organoleptic properties of the nutritional substance.

To solve the aforementioned limitations and to enable a conditioner to condition or process a nutritional substance with more sophisticated recipes, the inventors have developed inventive conditioners and control systems. In some embodiments, conditioners are provided that power conditioning elements for percentage of a time of a cycle (where a cycle may have a length of 1, 2, 3, 4, 20, 30, 60 seconds or hours). During each temporal cycle, each required conditioning element may be activated for only a percentage of the full time of the temporal cycle. This percentage of time may be varied to accommodate different requested percentages of power of the conditioning element.

In one aspect, embodiments of the present invention provide n conditioner for conditioning nutritional substance, where the conditioner comprises: at least two conditioning elements; a memory containing machine readable medium comprising machine executable code having stored thereon instructions for performing a method of conditioning nutritional substance; and a control system coupled to the memory. The control system is configured to execute the machine executable code to cause the control system to: receive, at the control system, a conditioning program comprising instructions to activate at least one conditioning element at regular intervals during at least two steps, each step comprising a series of identical cycles wherein each of the at least one conditioning element is activated for a certain percentage of each of the series of identical cycles and wherein each series of identical cycles is different for at least two of the at least two steps; execute the conditioning program and thereby activate the at least one conditioning element for the percentages required by each of the at least two steps; and advance to a next step of the at least two steps, when a target time or temperature is achieved for each of the at least two steps.

In some embodiments the control system is further configured to execute the machine executable code to cause the control system to maintain a target temperature for each step over a target time. The target temperature is defined as at least one of: the temperature of the conditioner compartment, the surface of the nutritional substance, or the inside of the nutritional substance. The temperature may be determined by data output from a thermistor, an infrared sensor, or a temperature probe.

The conditioning elements may be any suitable type, such as for example without limitation a: bake conditioning element, broil conditioning element, microwave conditioning element, convection conditioning element, grilling conditioning element, or any combination thereof.

In another aspect, embodiments of the present invention provide a method for conditioning nutritional substance using an conditioner, comprising the steps of: receiving, by an conditioner, a conditioning program comprising instructions to activate and deactivate at least one conditioning element of the conditioner at regular intervals during at least two steps, each step comprising a series of identical cycles wherein each of the at least one conditioning elements are activated for a certain percentage of time of the series identical cycles and wherein each series of identical cycles has a different target time or temperature for at least two of the at least two steps; executing the conditioning program and thereby activating the at least one conditioning element for the percentages of total cycle time required by each of the at least two steps; and advancing to a next step in the at least two steps, when a target time or temperature is achieved for each of the at least two steps.

In some embodiments, the method may further comprise receiving data output from a sensor relating to physical attributes detected by the sensor of the nutritional substance; and customizing the conditioning program based on the data.

Any suitable sensor capable of detecting or sensing a physical attribute of a nutritional substance may be used. In one example, the sensor is a weight sensor and a time of at least one of the at least two steps is proportionally decreased based on a difference between a weight of the nutritional substance determined from the data and a baseline weight for a type of the nutritional substance. In another example, the sensor is a temperature sensor and a time of at least one of the at least two steps is proportionally decreased based on a difference between a temperature of the nutritional substance determined from the data and a baseline temperature for the type of nutritional substance.

To further illustrate embodiments of the present invention, in the instance where baking requires most of the power available, the baking element may be turned on (at 100% power) for 50% of the time in each temporal cycle. Accordingly, this would leave open the other 50% of the temporal cycle for other conditioning elements to be utilized. Therefore, conditioners of the present invention may execute programs that require multiple conditioning elements that would otherwise exceed the available power for a single phase or step of the conditioning program if they were to be used simultaneously. In this manner, the inventive conditioning element management approach allows the heating elements to be alternated or staggered without exceeding the maximum power input to the conditioner. The combination of conditioning elements is defined by the conditioning requirements of the nutritional substance, not by the limitations of the appliance.

The accompanying drawings, which are incorporated in and constitute a part of this specification, exemplify the embodiments of the present invention and, together with the description, serve to explain and illustrate principles of the invention. The drawings are intended to illustrate major features of the exemplary embodiments in a diagrammatic manner. The drawings are not intended to depict every feature of actual embodiments nor relative dimensions of the depicted elements, and are not drawn to scale.

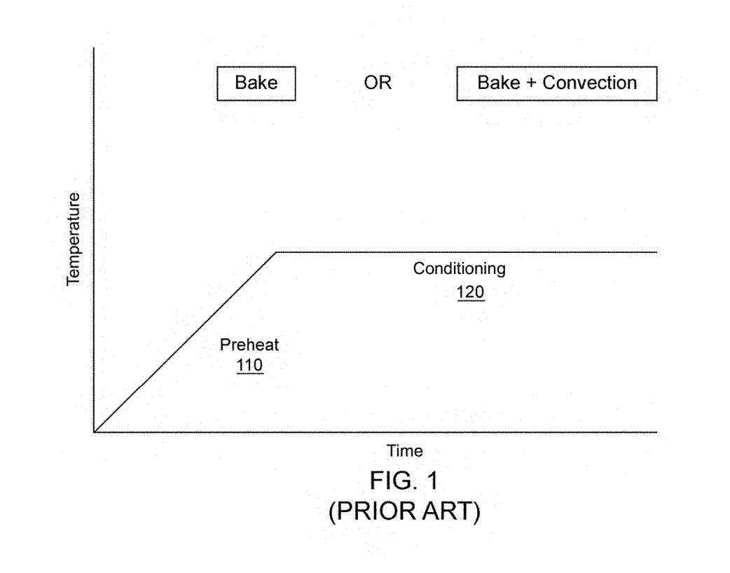

FIG. 1 a graph illustrating a prior art process for a conventional conditioner;

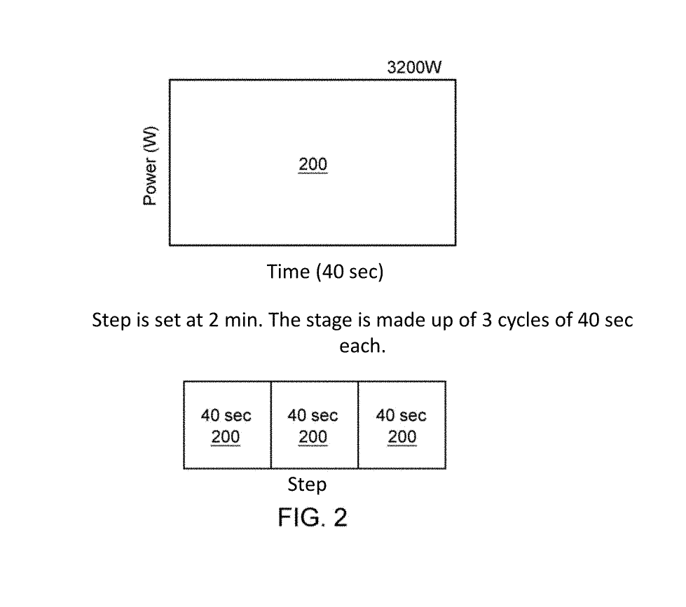

FIG. 2 is a diagram illustrating a conditioner implementing cycles of repeated units in accordance with various embodiments of the present invention;

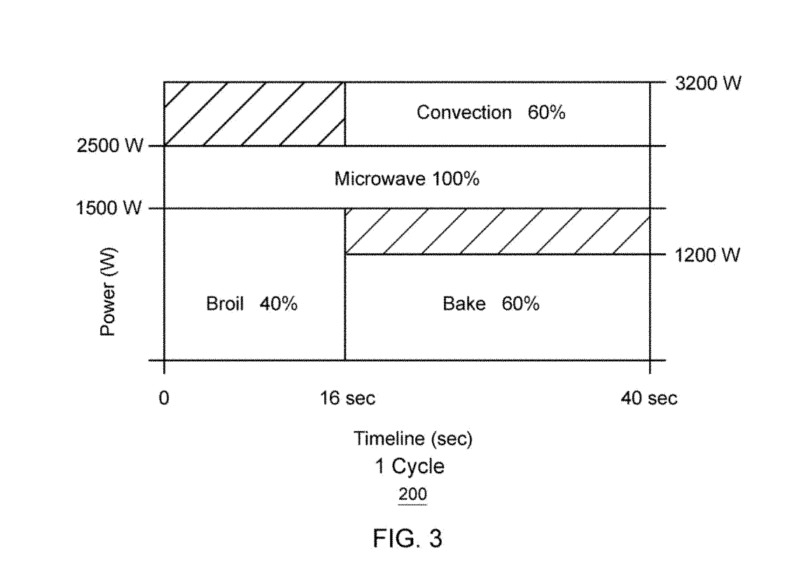

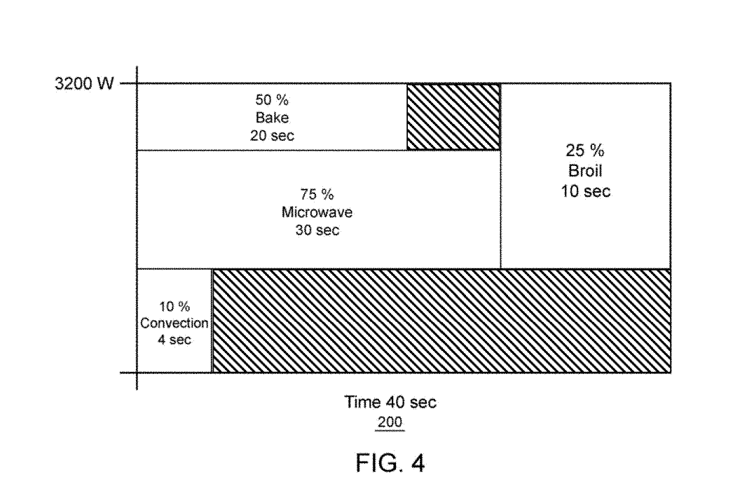

FIG. 3 is a diagram illustrating the breakdown of conditioning elements implemented by an conditioner during a cycle in accordance with various embodiments of the present invention;

FIG. 4 depicts, a diagram illustrating the breakdown of conditioning elements implemented by an conditioner during a cycle in accordance with various embodiments of the present invention;

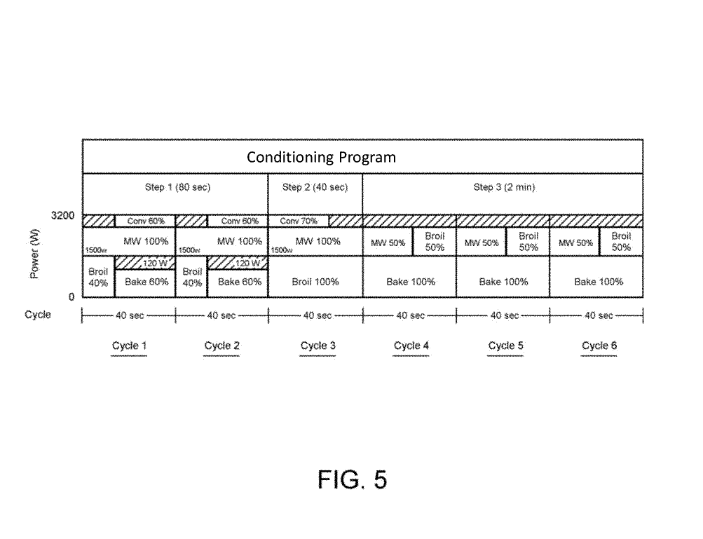

FIG. 5 depicts a diagram illustrating the breakdown of conditioning elements implemented by an conditioner over various steps that each include repeating cycles, in accordance with various embodiments of the present invention;

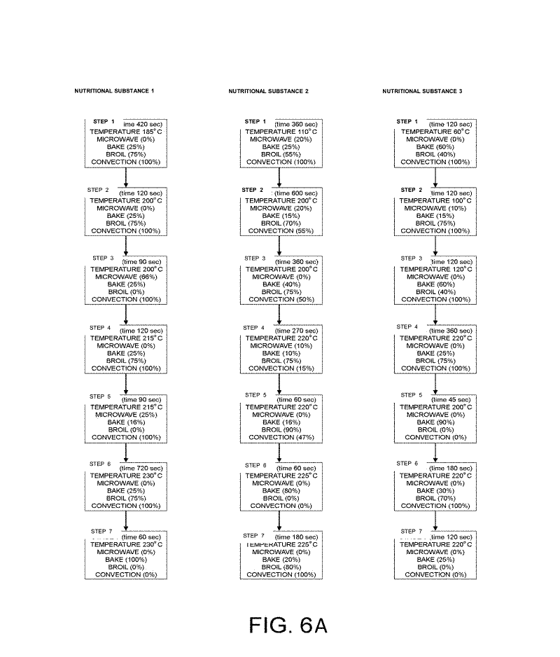

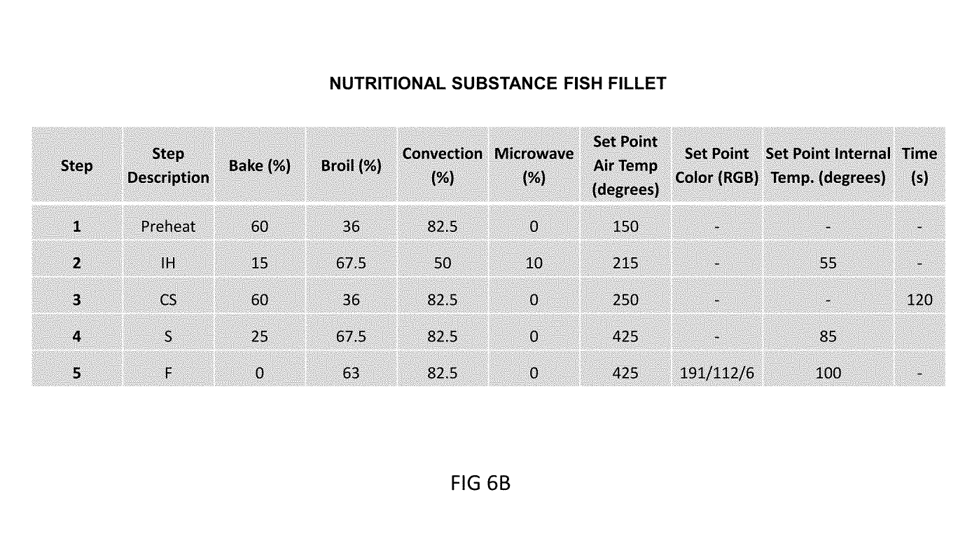

FIG. 6A and FIG. 6B show flow charts illustrating several examples programs that may be implemented by an conditioner in accordance with various embodiments of the present invention;

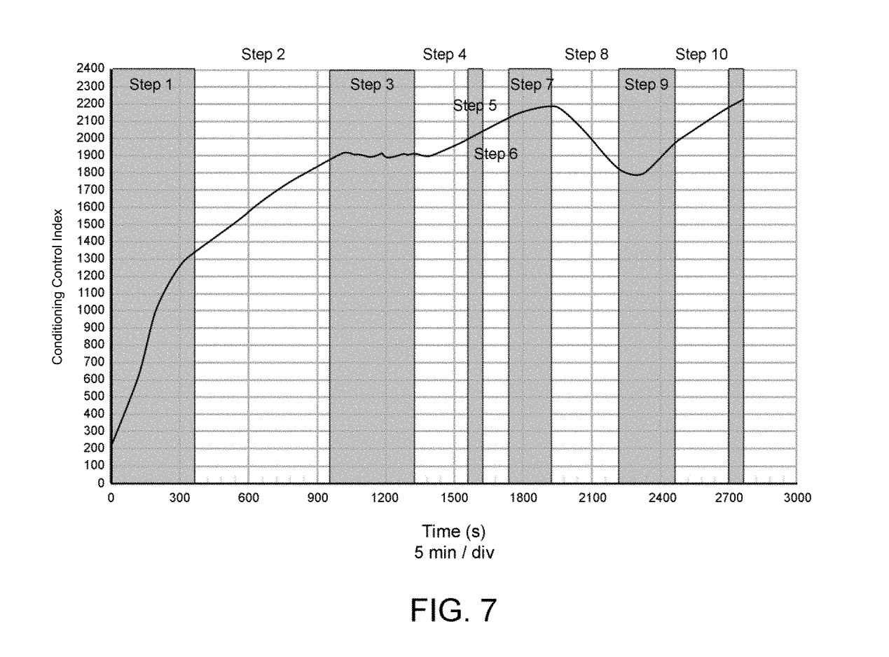

FIG. 7 is a graph illustrating the temperature and time progression over various steps implemented by an conditioner, in accordance with various embodiments of the present invention;

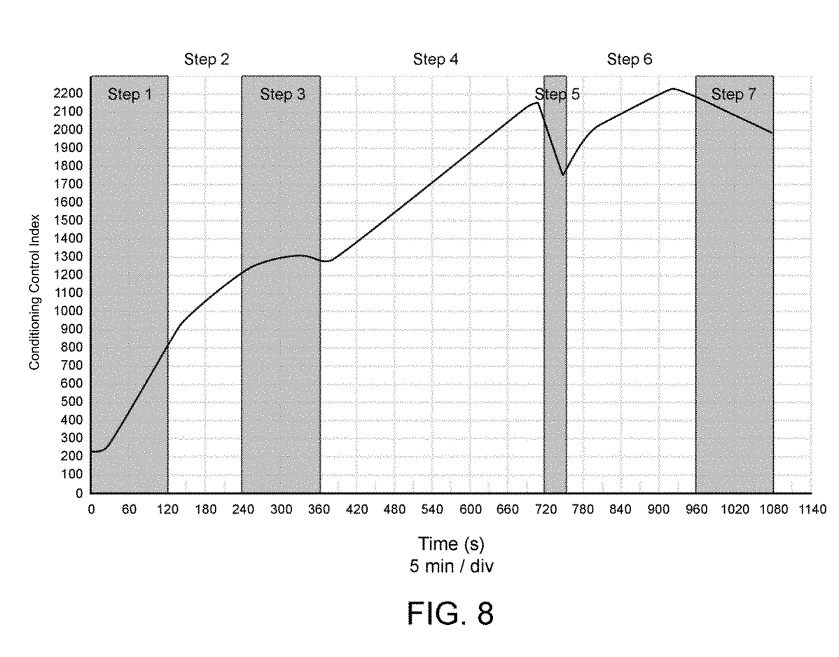

FIG. 8 depicts a graph illustrating the temperature and time progression over various steps implemented by an conditioner, in accordance with various embodiments of the present invention;

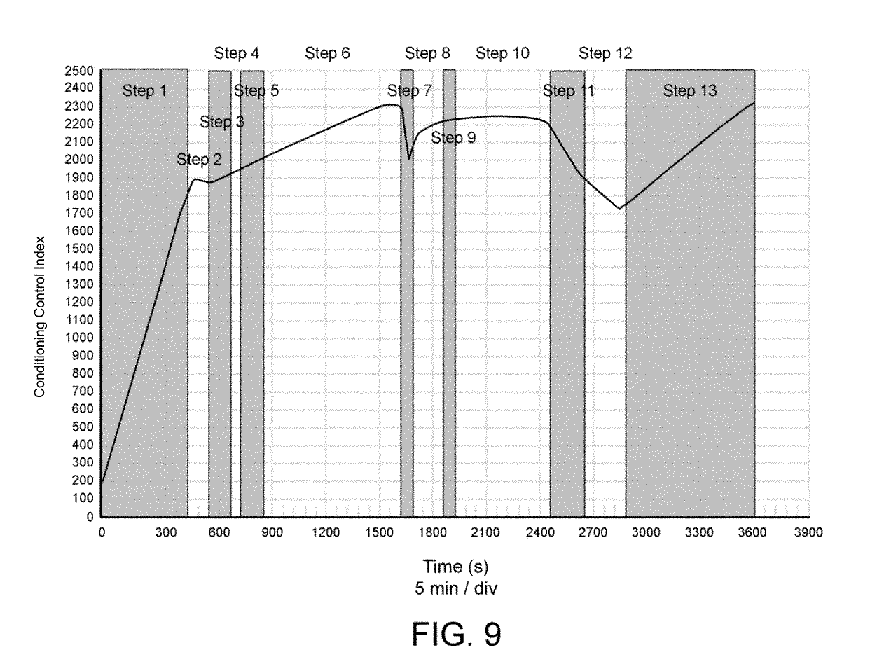

FIG. 9 depicts a graph illustrating the temperature and time progression over various steps implemented by an conditioner, in accordance with various embodiments of the present invention;

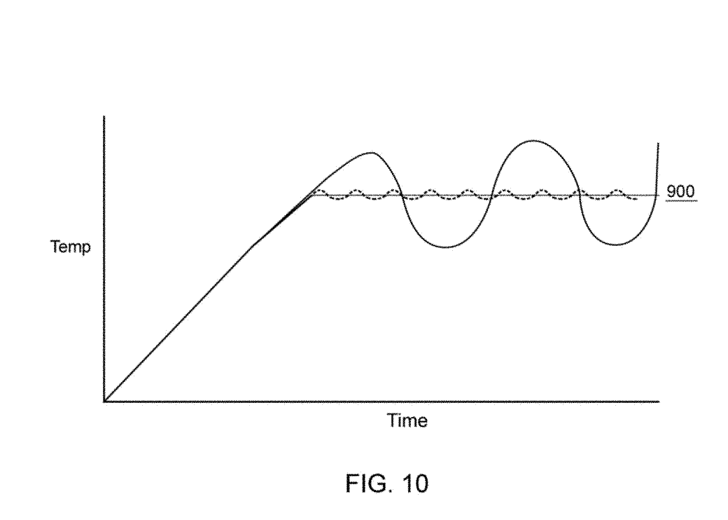

FIG. 10 shows a graph illustrating the temperature curves of a convectional and improved conditioner that are set to maintain a target temperature, in accordance with various embodiments of the present invention;

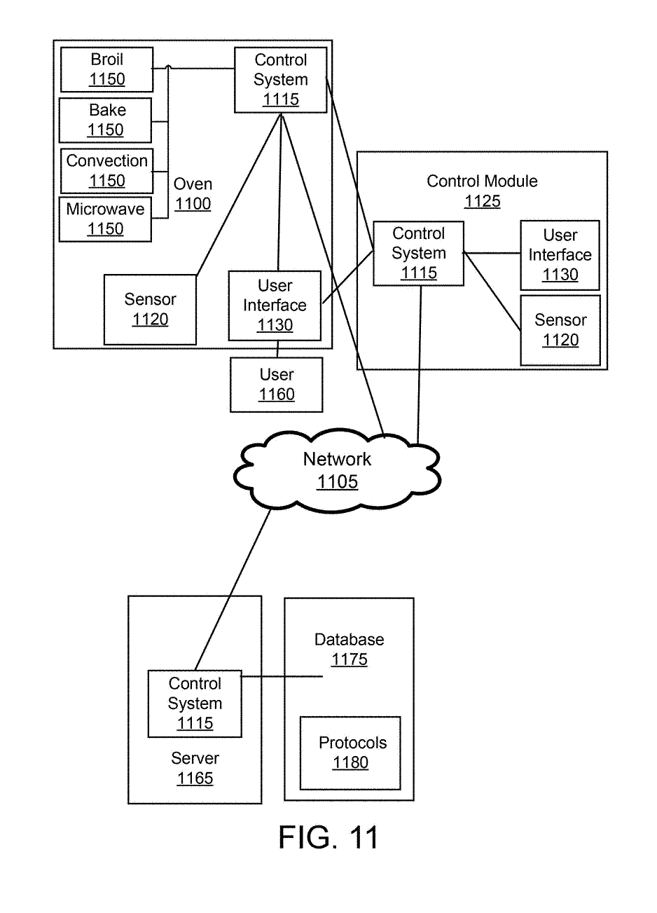

FIG. 11 is a schematic diagram illustrating a conditioner system, in accordance with various embodiments of the present invention;

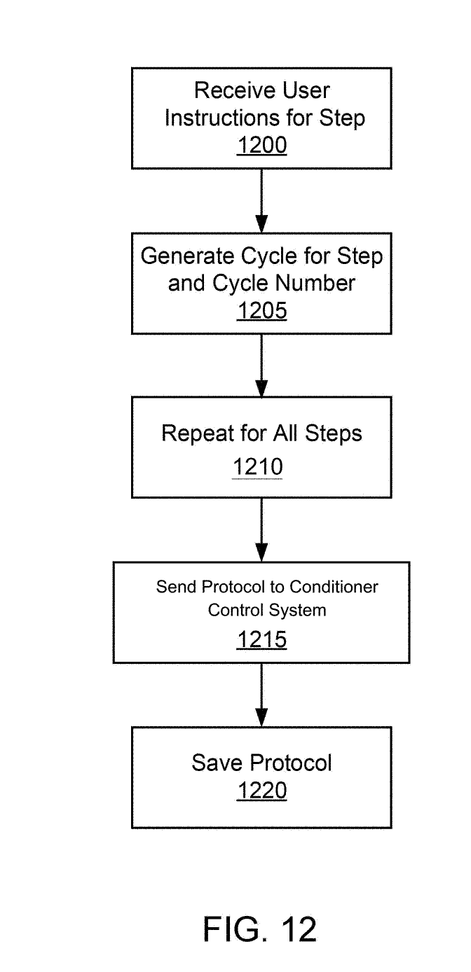

FIG. 12 depicts a flow chart illustrating a process for generating a program, in accordance with various embodiments of the present invention;

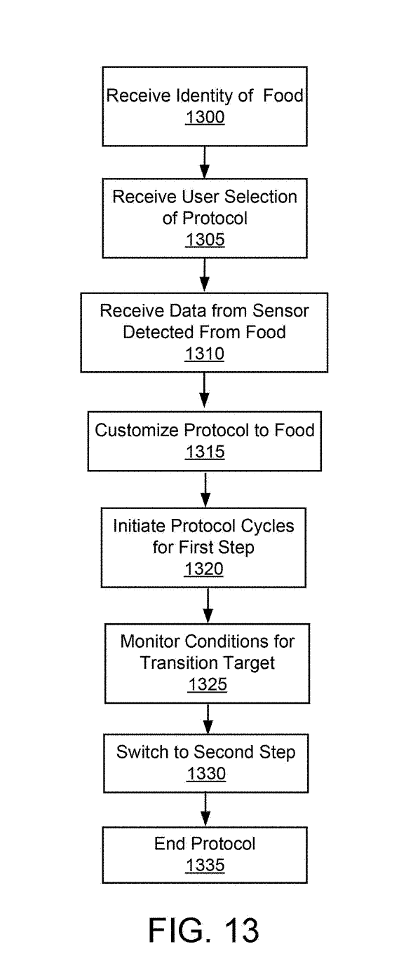

FIG. 13 depicts a flow chart illustrating a process for customizing and executing a program in accordance with various embodiments of the present invention;

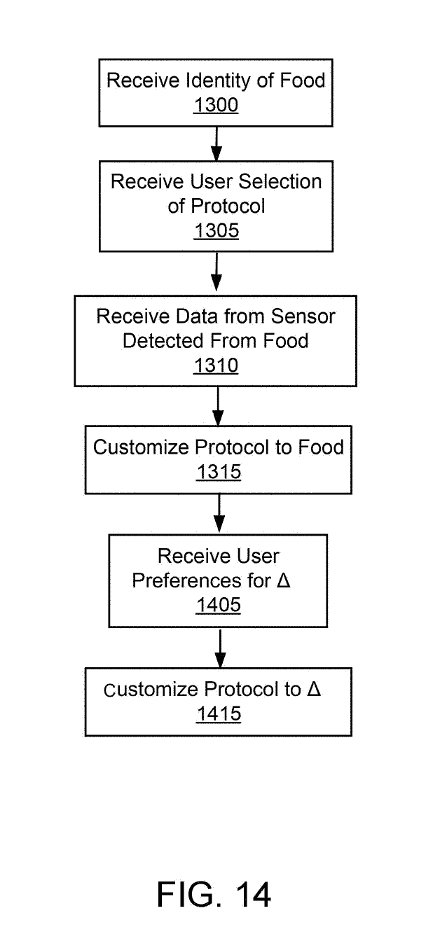

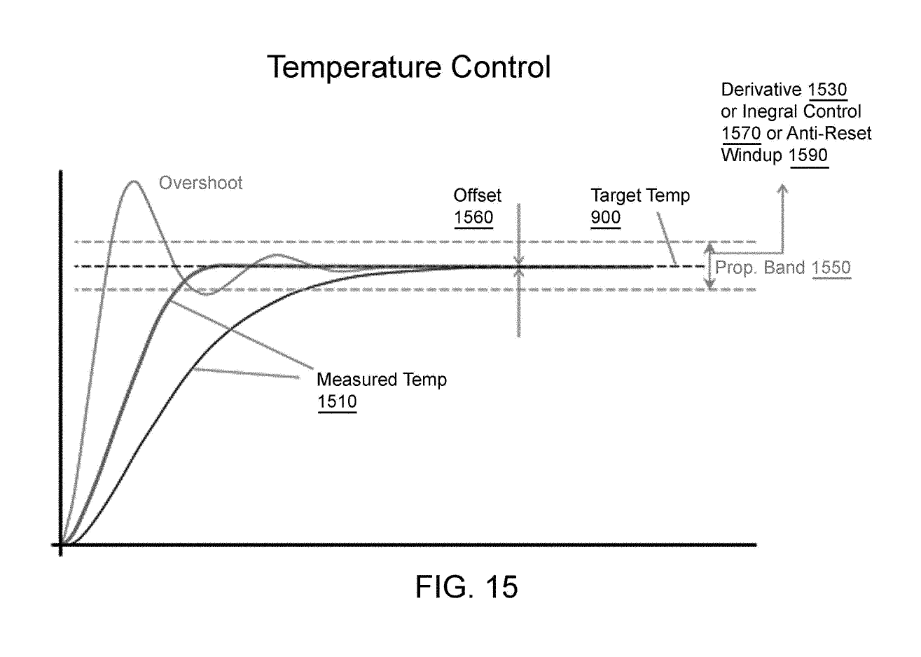

FIG. 14 a flow chart illustrating a process for customizing a program to a ΔN in accordance with various embodiments of the present invention;

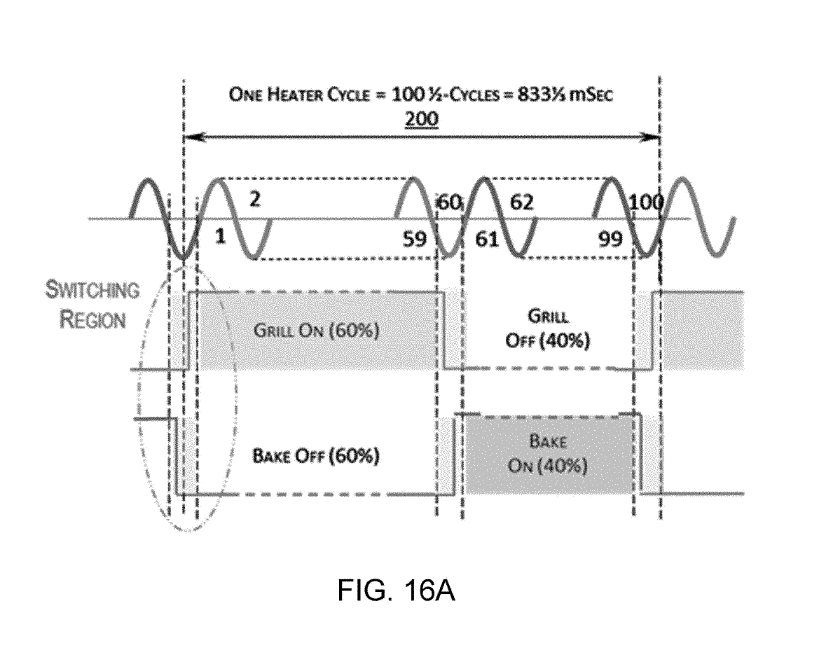

FIG. 15 depicts a graph illustrating proportional control, in accordance with various embodiments of the present invention; and

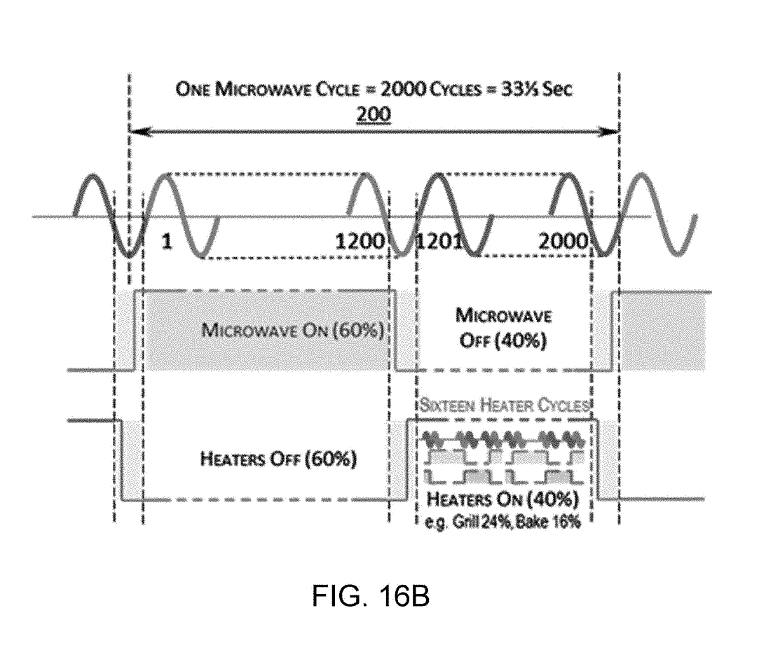

FIG. 16A and FIG. 16B are graphs illustrating asynchronous ½ cycle PWM control schemes, according to various embodiments of the present invention.

In the drawings, the same reference numbers and any acronyms identify elements or acts with the same or similar structure or functionality for ease of understanding and convenience. To easily identify the discussion of any particular element or act, the most significant digit or digits in a reference number refer to the Figure number in which that element is first introduced.

### DETAILED DESCRIPTION

As described in detail below, disclosed herein are systems and methods for power management and temperature control that minimize conditioner power management inefficiencies and help to maximize conditioner cavity thermodynamics which provide beneficial reduction of conditioning time, better control of the conditioning process, higher residual nutritional content and organoleptic properties of the nutritional substance, among other advantages.

In some embodiments, properties such as dimensions, shapes, relative positions, and so forth, used to describe and claim certain embodiments of the invention are to be understood as being modified by the term “about.”

Various examples of the invention will now be described. The following description provides specific details for a thorough understanding and enabling description of these examples. One skilled in the relevant art will understand, however, that the invention may be practiced without many of these details. Likewise, one skilled in the relevant art will also understand that the invention can include many other obvious features not described in detail herein. Additionally, some well-known structures or functions may not be shown or described in detail below, so as to avoid unnecessarily obscuring the relevant description.

The terminology used below is to be interpreted in its broadest reasonable manner, even though it is being used in conjunction with a detailed description of certain specific examples of the invention. Indeed, certain terms may even be emphasized below; however, any terminology intended to be interpreted in any restricted manner will be overtly and specifically defined as such in this Detailed Description section.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations may be depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

### Overview

As used herein, one or more consecutive and identical cycles make up a step, and multiple steps make up a conditioning program. A user can program the conditioners and/or control systems with different steps that use different combinations of conditioning elements in the cycles for each step. Accordingly, each step in the conditioning program will include identical cycles within the same step, but the cycles may vary between different steps. Furthermore, the system may automatically distribute the different activation of conditioning elements during the cycle to maximize power usage during the cycle.

### Step Transitions

To transition between the steps, the conditioner system may include time or temperature (e.g. temperature of the cavity or nutritional substance) or any other measurable attribute, target or trigger for transitioning between steps. For example without limitation, a measurable attribute, target or trigger could include aroma or organic volatiles released by the nutritional surface into the cavity, compositional changes of the nutritional substance, color of the surface of the nutritional substance, load cells to measure the nutritional substance weight, relative humidity inside the cavity, among others. For instance, the user (or control system if using a conditioning program already defined) may input a target time for each step that would simply transition between the steps when the time is elapsed during conditioning. In other examples, the conditioner system may have target temperature that could be reached using feedback from various mechanisms, such as: a simple thermistor (to sense the conditioner cavity environment), an infrared temperature sensor (to sense the surface temperature of a nutritional substance item), or a temperature probe (to sense the internal temperature of the nutritional substance), and the like. Additional examples include a chemical sensor or electronic noses that can detect the change in the amount of aromas or volatile compounds released by the nutritional substance inside the conditioner cavity and trigger a transition between steps once the trigger value has been reached. In other embodiments, a spectral sensor can trigger a transition between steps based on compositional changes (e.g. nutritional content, denaturation of proteins, transformation of lipids and carbohydrates) of the nutritional substance; a relative humidity sensor can trigger a transition based on the humidity levels inside the cavity; or a load cell can trigger a step transition based on changes in weight of the nutritional substance. Accordingly, each step may be separately programmed for one of these targets or combination of these targets to trigger a transition between steps.

A step may have any suitable duration, and may be dynamic in duration. In some embodiments a step may have a duration of the sooner of: (1) the time it takes for a temperature to reach a certain target or (2) a certain time elapses for that step. Additionally, these concepts may be utilized to implement a function in the conditioner with a single step using the power management cycles described herein.

Accordingly, each step may be separately programmed for one of these targets or combination of targets to transition to the next step. In one example, the duration of a step may last until the sooner of: (1) the temperature reaches a certain target; (2) a certain time elapses for that step; (3) the aroma of certain volatile reaches a certain level in the conditioner cavity; (4) the surface color of the nutritional substance reaches a target color; (5) the spectral sensor of the nutritional substance detects that the nutritional substance reached a target composition; (6) the weight of the nutritional substance decreases and has reached its target weight; (7) the relative humidity detected a trigger based on humidity levels inside the cavity; (8) other sensors targets are reached; or any combination of the foregoing. Additionally, these concepts can be utilized to implement a function in the conditioner with a single step using the power management cycles described herein.

Accordingly, the steps can be used as a collection to form conditioning programs that can be implemented by a conditioner to condition specific types of nutritional substances. The conditioning programs may be dynamically modified based on weight, internal temperature, composition, geometry and shape (e.g. thickness in a cut of meat), origin (such as Norwegian vs Atlantic salmon) and type (e.g. organic vs non organic, pesticide free, and the like) of the nutritional substance. In one example, if a user inserts different weights of a type of nutritional substance or the conditioner detects the weight of the nutritional substance, the conditioner system may adjust certain steps appropriately to account for differences in weight. For instance, certain steps may be impacted by the weight and therefore the target time or temperature may be proportionally (or by some other logic or correlation equation) reduced or increased to account for variation from a baseline weight of the nutritional substance item. In an illustrative example, if a chicken is 6 pounds, and the conditioning program is designed for a 3 pound chicken, the time for certain steps may be modified. In one example, the time of a certain stem may be modified by increasing the time by particular percentage (such as approximately 150%), by some other factor, or according to some equation or curve. Other parameters of the conditioning program may also be modified. In some embodiments, the conditioning program may be modified in terms of target weight, cavity temperature, internal temperature of the nutritional substance, internal composition of the nutritional substance, aroma released by the nutritional substance and relative humidity inside the cavity, and the like. Accordingly, for the same conditioning program, the only change is to the time of all or some of the steps. Furthermore, different steps may increase or decrease by different amounts of time or remain the same.

### Conditioning Elements

Using these sophisticated control methods, a system can control a variety of conditioning elements in the conditioner. In some examples, the conditioner system may control conditioning elements on the top (such as a broil element), bottom (such as a bake element), back or side (such as convection element). Of particular advantage, the flexibility of the control system and method of the present invention enables the integration of other options including microwave in the conditioning cycles. The control system in the conditioner may be programmed to automatically stagger or distribute the activation of the conditioning elements over repeating cycles looking for an optimal use of power resulting in reduced conditioning time. This allows the system to provide selected, desired or optimized residual nutritional values in the processed nutritional substance. Further, the control system may automatically distribute the activation over the cycle in such an arrangement that prevents the power requirements from exceeding the maximum.

### Regulating Temperature

The conditioner system uses a specialized process and feedback to maintain a target temperature over a time period. Conventional convectional conditioners generally use an on/off system to switch the conditioning elements associated with the selected conditioning setting “on” when the temperature drops below a threshold and “off” when the temperature passes a threshold. Because the conditioning elements are switched entirely on and entirely off for the duration of time until the threshold is reached, the margin of error and delay between the temperature rise and the reaction creates quite a bit of over and under shooting of the temperature. This causes the temperature to undulate around the target but with a relatively high degree of error.

To address this problem the inventors developed an inventive conditioner system that proportionally decreases the percentage of time each element is on during each individual cycle so that the temperature rises slower as it approaches the target. Additionally, the power is reduced by a percentage rather than entirely shut off when the temperature crosses a threshold (upper and lower limits of the control band). Accordingly, this reduces the over and under shooting while maintaining a temperature. According to some embodiments, the control system is implemented by any one or more of: a step controller, a proportional controller, proportional derivative (PD) controller, proportional integral (PI) controller, or a proportional integral derivative (PID) controller.

The regulation parameters may be modified based on the types of sensors and their response times. Sensors do not change output state immediately when an input parameter change occurs. For example, a standard or fast response temperature sensor, such as a thermocouple, reacts to a change in temperature relatively fast. Other sensors traditionally used in conditioners, such as thermistors, take longer to read a change in temperature, that is, they have a slower response time. Therefore, conditioners using sensors with slow response time tend to show higher temperature fluctuations above and below the temperature set point, i.e. higher degrees of temperature overshooting and undershooting.

This novel method of control may be applied to any number of functions. For example, the control system may be applied to the temperature inside the cavity, the surface temperature of the nutritional substance, and/or the temperature inside the core of the nutritional substance. The control system may also be applied to compositional changes in the nutritional substance, the surface color of the nutritional substance, aromas or organic volatiles released by the nutritional substance inside the cavity, the weight of the nutritional substance and relative humidity inside the cavity. In some examples, reducing the percentages as the core temperature or other cavity or product attributes approaches the target may be particularly advantageous, because of the delay between the response time between the sensor readout and the actual cavity or nutritional substance attribute change.

Turning to the figures, disclosed are systems and methods that minimize conditioner power management inefficiencies and help to maximize conditioner cavity thermodynamics resulting in a significant reduction of conditioning time, higher residual nutritional content and improved nutritional substance taste, texture an appearance. FIG. 1 illustrates an example of a time and temperature curve for a conventional conditioner. The conditioner is set to preheat 110 to a specified target temperature 120, and usually only one or two conditioning elements will be utilized. The conditioning elements generally include one that is convection based, a bottom conditioning element for baking, a top conditioning element for broiling and potential combinations. For instance, most conditioners try to preheat 110 as fast as possible, and so if the conditioner is set to bake at 400 degrees, the conditioner will activate the bake and broil conditioning elements, until 400 degrees is reached 120. Then, the conditioner will maintain the internal temperature of the conditioner at 400 degrees 120 until the user cancels or a specified time elapses.

However, a conditioner could condition nutritional substance more precisely and with better results if combinations of conditioning elements could be used at different times throughout a conditioning program to more finely tune the conditioning process. Most convectional conditioners do not have a microwave option (that conditions from the inside out) and therefore, recipes that require microwaving require the user to take the nutritional substance back and forth between the microwave and the conditioner. Furthermore, if the conditioning elements used during the conditioning process could be changed, the appropriate conditioning elements could be turned on at the relevant steps. For instance, if the nutritional substance is on the top shelf and the last step would be to make the outside crispy, if the conditioner could be programmed to turn the broiler on at high for the last few minutes the conditioning programs could be much more optimal and versatile.

One of the largest obstacles to using multiple conditioning elements is that the conditioner generally has a limit on the amount of power that can be utilized at any one time due to the limits of standard electrical sockets, and power supplies, etc. Accordingly, in some examples, if 3200 watts total is available, no more than that amount of power may be utilized for conditioning at any one time. Additionally, since most conditioning elements are either 100% on or off, they may not be partially activated. If the broiling, baking and convection conditioning elements each consume most of the 1800 watts of energy, it would be impossible to simultaneously, bake, broil and run the convection conditioner element if the maximum available power is 3200 watts. Rather, these would need to be done in series (first bake & broil, then convection for example).

Alternatively, as illustrated in FIG. 2, conditioners of the present invention are configured to operate the conditioning elements using repeating cycles 200 that are the same length of time, but include staggered activation of the conditioning elements. As shown in FIG. 1, if 2 minute of conditioning is needed with a certain combination of conditioning elements for a given conditioning step, those conditioning elements may be staggered within a cycle 200 length of 40 seconds (or for example 10 seconds, 20 seconds) and then the cycle repeated three times.

The only requirement is that the total power (e.g. 3200 watts), is not exceeded by any combination of conditioning elements activated at one time. For example , if the broil element draws 1500 watts, the microwave element 1000 watts and the bake element 1200 watts, not all the elements can be turned on at the same time, as the sum of all the power draw by the heating elements is 3700 watts, exceeding the 3200 watts available. In this instance, the following combinations can be turned on simultaneously: broil and microwave, broil and bake, and bake and microwave. Therefore, different combinations of conditioning elements may be activated for set periods during the cycle as long as the total power drawn by the combination of the conditioning elements used exactly at the same time does not exceed the power available.

FIG. 3 illustrates an example of cycle 200 and the breakdown of conditioning elements used during the cycle 200. In this example, each conditioning element is activated to 100% amount while it is on, and therefore the power shown is the full power for that conditioning element. For example, in the first 16 second time slot, the top conditioning element (e.g. broil for short hand) and microwave conditioning element are activated. Since the broil conditioning element is only activated for 16 seconds, it is counted at 40% even though when it is activated it is outputting at 100%. It is important to note that the total amount of power used by broil and microwave in this 16 sec is 2500 watts, below the maximum power allowed of 3200 watts, given that the broil conditioning element is shown consuming about 1200 watts, while the microwave is shown consuming 1000 watts. There are still 700 watts of heating available; so, if required, the 700-watt convection element could be used.

Additionally, the microwave conditioning element is on 100% of the time in cycle 200 (the full 40 seconds), and it is at full power. The convection and bake conditioning elements are each turned on for 24 seconds (but at 100% power) of the cycle 200 and therefore they are considered 60% power for this cycle 200. In this manner, all the heating elements are used without exceeding the maximum power available. This approach not only allows for power optimization by maximizing heating element efficiency, but also allows the user the possibility of combining different heating elements to direct the heat from different directions to the nutritional substance within a given set of cycles or step. In this example, for the first 16 sec of the cycle, the nutritional substance is conditioned with the heat aimed at its top surface (broil) for color development through Maillard reactions and to the inside (microwaves) to increase the internal temperature more efficiently. In the remaining 34 sec of the cycle, the heat is aimed at the bottom surface (bake), to the inside (microwave) and top and side surfaces (convection) of the nutritional substance. Convection in this case is used to promote rapid and even heat on the top and side surfaces of the nutritional substance.

FIG. 4 illustrates a second example of a cycle 200 and the breakdown of conditioning elements. In this example, the conditioning elements associated with bake and broil (illustrated as “bake” and “broil” for simplicity but generally referring to the top and bottom conditioning elements) are shown to consume different amounts of power as different types of conditioning elements may be utilized on the conditioner during the cycle 200. The heating elements and sequence used in this cycle are different from the one illustrated in FIG. 3, as, for instance, different nutritional substances require different heat treatments. This difference may be also due to the conditioning state of the nutritional substance as it is being conditioned, its weight, composition, geometry and shape, and internal temperature. The optimum heat treatment is different at the beginning of the conditioning process than at the middle or end, given that the nutritional substance is evolving and its heat requirement changes during the conditioning process. At the beginning of the conditioning process, for some nutritional substances such as proteins, the objective is to increase the internal temperature of the nutritional substance, so convection in combination with broil and/or bake is usually used. In the middle microwave and convection is used to develop internal texture, whereas broil and convection is used at the end to develop external color, texture and aromas. Accordingly, for each conditioner that utilized different combinations of conditioning elements, different cycle 200 types will be programmed or determined based on the power usage of each conditioning element.

FIG. 5 illustrates an example of an entire conditioning program 500 that includes several different steps 510, each with their own repeating cycles 200. Accordingly, FIG. 5 provides a visual schematic to illustrate the conditioner's conditioning process as implemented over an entire program from start to finish. For instance, each step includes various identical cycles 200 that are each 40 seconds long and that repeat over the course of the step.

Step 1 has two identical cycles of 40 seconds each for a total of 80 seconds. For each cycle 200 in step one, the conditioning elements activated are first broil and microwave, and then broil is turned off and convection and bake are turned on for the remaining portion. In step 2, broil and microwave are used at 100%, whereas convection is used at 70%. The difference between Step 1 and Step 2 reflects a change due to a change in the state of the food. While the microwave remains the same in both steps in order to continuously increase the internal temperature of the nutritional substance, the bake is eliminated and broil and convection increased to 100% and 70% respectively to develop internal texture and start to crisp and color the surface of the nutritional substance. Step 3 eliminates convection, decreases microwave and broil to 50% and adds bake at 100%. This allows for the development of a crust at the bottom of the nutritional substance, in this case bake goods, while decreasing the amount of color development and preventing overheating the surface. Depending of the product, the definition and duration of the cycles, the duration and number of the steps vary depending on the type of nutritional substance, composition, shape, geometry conditioning state, internal temperature, amongst other variables. Accordingly, an entire conditioning program may be constructed from a series of steps as illustrated. As long as the conditioning elements activated at any time do not exceed the maximum power available, the cycle 200 will be appropriate.

FIG. 6A illustrates three different examples of flow charts of example conditioning programs 500 that include several different steps 510. In this example, each step 510 will include repeating identical cycles 200 of a set time span that activate the indicating conditioning elements for the indicated percentage of time during the cycle 200. For each step, the flow charts indicate a target temperature 120 or time, and percentage time each conditioning element is activated for the cycle 200. Furthermore, each flow chart represents a conditioning program for a specific nutritional substance with a specific weight, internal temperature, composition and shape. For example, if another nutritional substance with the same attributes as nutritional substance 1 but with different initial weight, the duration of one or more steps would need to be modified in order to achieve the same conditioning results, in terms of organoleptic characteristics. Additional changes can also be required depending on by the conditioning state of the nutritional substance, or the power output of the heating elements. If in a given step the state of the nutritional substance has not yet achieved its target value, which could be in terms of color (detected by optical sensors), aroma level (detected by chemical sensors), or weight (detected by load cells) the duration of the step can be increased until the target is reached, before moving to the next step. On the other hand, if the target conditioning state of the nutritional substance has been reached before the time has elapsed for that step, the program can move to the next step regardless of how much time was left in the prior step.

As described above, the transition to a next step during a conditioning program may be based on various logical factors related to reaching (1) the target temperature 120 and/or, (2) the time, and/or (3) aroma or volatile level inside the cavity and/or (4) surface color, and/or (5) composition, and/or (6) weight of the nutritional substance and/or (7) relative humidity in the cavity and/or (8) other factors or feedback from other sensors. In some embodiments, certain steps may be based on a target temperature alone, which may be a cavity thermistor or sensor that detects the temperature inside of the conditioner chamber. In other embodiments, the target temperature 120 may be based on the surface of the nutritional substance as detected by an infrared sensor, or may be on the inside of the nutritional substance as detected by a temperature probe, or may be based on surface color of the nutritional substance as detected by optical sensors, colorimeters or cameras, or may be based on weight of the nutritional substance, as detected by load cells, or may be based on the internal or external composition of the nutritional substance, as detected by spectral sensors inside the nutritional substance, or may be based on aroma or organic volatiles released by the nutritional substance as detected by chemical sensors or electronic nose.

In some examples, the time selected may be the only factor considering the switching between steps, and the conditioner will simply transition to the next step once a set time has elapsed. In this case, generally the conditioner will maintain the temperature at the target temperature 120 until the time is elapsed. In other examples, the time and temperature may both be a maximum (triggering transition whichever is first). In other examples, multiple temperature readings may be available from different sources including infrared (surface of nutritional substance), conditioner cavity temperature or from the temperature probe placed inside nutritional substance. Each of these temperature readings could trigger a transition to a next step or could be a target temperature that the conditioner regulates 120. In other examples without limitation, a target temperature is based on readings output from a temperature probe; a target composition of the nutritional is based on the reading outputs of a spectral sensor; a target volatile inside the cavity is based on the reading outputs of a chemical sensor or electronic nose; and/or a target weight is based on the reading outputs of a load cell.

For instance, if the nutritional substance is fish fillet with skin on, the initial conditions of the nutritional substance are taken into account to select the conditioning program, illustrated in FIG. 6B. The initial conditions may include, but not limited to weight (1.5 lbs), internal temperature (40 degrees) and composition in terms of fat content (10% intramuscular fat). The conditioner has the following conditioning elements: bake, broil, convection and microwave with a power of 1500 watts, 1100 watts, 700 watts and 1500 watts, respectively. The nutritional substance properties at the end of the conditioning process are defined as follows: internal temperature is 100 degrees, with a target color of 191/112/6 RGB color. The sensors used to control and define transition between steps are color of the nutritional substance, cavity temperature, and color of the surface of the nutritional substance.

The conditioning program shown in FIG. 6B is an exemplary illustration of the steps required to condition the fish fillet based on desired target based on food safety and organoleptic requirements. Each step is labeled according to the functional conditioning is performing on the nutritional substance. The fillet is placed skin side down on the conditioner pan. The function of the first step is to Preheat (P) both the oven cavity and the surface of the nutritional substance. In this step the conditioning elements gradually heat up the air in the cavity and starts increasing the temperature of the surface of the fillet. In addition, convection helps evaporate early surface moisture while the bake starts the dehydrating process of the skin. On the top part of the fillet flesh, facing up towards the broiler, the surface moisture will begin to evaporate by convection. As the power of the broiler is high in this conditioner, the power must be set low to avoid overcooking the surface protein which would lead to browning too quickly. Once the set point temperature of the cavity is reached, step 1 ends, delineating a transition to step 2. The function of step 2 is internal heating (IH) the nutritional substance, that is, the internal temperature starts to increase and the microwave conditions the internal proteins and fats of the fillet. The internal temperature in this step should reach 55 degrees before transitioning to step 3, conditioning and sculpting (CS). The transition between steps 3 and 4 is based on time. In step 3 the skin continues to dehydrate and the fish fat melts, as the fillet internal temperature continues to increase. The proteins continue to denature, sculpting or giving form to the fillet. The broiler helps maintain an elevated oven temperature that will continue to radiate heat to the surface of the salmon while the convention distributes heat to every surface of the salmon that is not in direct contact with the pan. Step 4, sculpting (S) continues to heat up the fillet internally, gradually sculpting the fillet. The height of the fillet starts to rise. As proteins begin to lose moisture they begin to contract within the muscle fiber and give the salmon a “swelling” effect, which happens when the internal temperature of the fillet is about 85 degrees. Once the internal temperature of the fillet reaches 85 degrees, it triggers a transition to step 6, finishing (F). During this step the broil with convection develop the final color and texture of the top side of the fillet. In this stage the albumin starts to seep out of the sides, which means that the internal temperature is approaching 100° F. The broil finish browning top surface of the fillet. This step is completed once the color of the surface of the fillet reaches an RGB value of 191/112/6.

FIGS. 7-9 illustrate examples of time and conditioning control index graphs implemented over a variety of steps. The conditioning control index profile is the result of executing a conditioning program, and, as the conditioning program, it varies depending on the type, weight, composition, shape/geometry and internal temperature of the nutritional substance. The conditioning control index is also a function of state of the nutritional substance during conditioning, and its response as detected by the sensors. The conditioning control index is a combination of output from one, two, or more sensors including conditioner cavity temperature, internal temperature of the nutritional substance, surface temperature of the nutritional substance, composition of the nutritional substance, aromas or organic volatiles in the cavity, weight of the nutritional substance and others. The conditioning control index may be utilized to monitor the conditioning program performance and if needed, the execution of corrective actions based on historical data, data analysis and machine learning. As illustrated, the complexity of these programs that include for example, many different steps allow a user to prepare nutritional substances using very finely tuned conditioning programs.

### Temperature Control

FIG. 10 is a graph illustrating two different outcomes of two different approaches to maintaining temperatures in a conditioner. The target temperature 900 is illustrated along the graph line. In convectional systems a conditioning element will remain on until the temperature reaches a threshold above the target temperature 900 and be switched off to allow the temperature to drop. Then, once the temperature drops below a threshold that is under the target temperature 900, the conditioning element(s) will be switched back on.

In these examples, as illustrated in FIG. 10, the temperature of the conditioner cavity overshoots which in this case is relatively large due to the relatively large response time of the thermistor. Furthermore, after the conditioning elements are shut off, the thermal inertia and residual heat in the active conditioning elements will keep the temperature rising until it reaches equilibrium and eventually drops. The higher the power of the conditioning elements and the set point temperature, the larger the overshoot by over, usually over 10 degrees. By the time the sensor detects the temperature being below the set point temperature, the actual cavity temperature will be much lower, by over 10 degrees, due to the delay in response to the thermistor which results in a temperature undershooting. Because the conditioning elements are left on at 100% as their only option is on or off completely, they typically have quite a wide margin of error in fluctuating around the target temperature 900.

### Proportional, Integral, Derivative Control

Accordingly, a conditioner control system has been developed that decreases the percentage time the conditioning elements are activated during a cycle 200 as the conditioner temperature (or nutritional substance temperature) approaches the target 900. In the example illustrated in FIGS. 3 and 4 of the cycles within a step of a conditioning program, when the temperature approaches the target temperature 900, the percentage of each conditioning element may be proportionally reduced continuously or in steps as the temperature approaches the target temperature 900. Similarly, when the temperature falls below the target temperature 900 the conditioning elements will be proportionally increased for their percentage time activation during the cycle 200, so that the undershoot will be far less. In order to illustrate this point and using the cycle of FIG. 3 as an example, the conditioner control system proportionally decreases the power of each heating element by proportionally reducing the time each heating element is on. For instance, when the thermistor temperature reads 15 degrees below the set point temperature, the conditioning elements run as prescribed by the conditioning program. Once the thermistor temperature reads between 15 to 10 degrees below the set point, the amount of time each conditioning element is on is decreased, which in this example, it decreases by 33%. Therefore, the broil would run at about 27%, the convection would run at 40%, the microwave at 67% and the bake at 40% of the time in this cycle. As the thermistor read out further approaches the set point temperature, say between 10 degrees and 5 degrees, the time each conditioning element is on can be further proportionally reduced by 66%. Therefore, the broil would run 13%, the microwave 33%, the convection and bake 20% of the time in this cycle. This minimizes the over shutting and temperature fluctuations as the cavity temperature reaches steady state around the set point temperature. Further optimization can be made by proportionally decreasing each conditioning element in a different way, depending on the power of the heating element. For instance, the broil, which has 1500 watts with the highest power according to this example, can be reduced at a higher rate than the convection, which only utilizes 1000 watts, given that the higher the power of a given conditioning element the higher the possibility for temperature overshoot. The same analogy can be used for any type of sensor that has a relatively large response time against the set point value of the attribute being measured and used as a trigger to transition between steps in a conditioning program.

This proportional increase or decrease could occur in steps or could continuously change as the temperature in the conditioner deviates from the target temperature 120. This will allow the target temperature 900 to more closely be maintained as the curve in FIG. 10 illustrates.

FIG. 15 depicts a graph with an example of proportional temperature control, which could also be used to control the conditioning process based on other attributes of the nutritional substance such as composition, aroma generation, weight and/or relative humidity. In some examples, where the temperature is the key parameter, the conditioner control system implements proportional control by determining the difference between the target temperature 900 and the measured temperature 1510 and then adjusting the percentage time each conditioning element 1150 is activated during a cycle 200. The amount of adjustment may be proportional to the magnitude of the deviation from the target temperature 900. When the measured temperature 1510 enters the proportional band 1550, the conditioning element 1150 power gradually becomes smaller and the measured temperature 1510 stabilizes somewhere within the proportional band around the target temperature 900. More specifically, a sensor measures and transmits the current value of the conditioning process variable, such as temperature, composition, relative humidity, aroma generation, back to the controller. The controller error is computed as the difference between the set target value (TV) 900 minus measured process variable 1510 (PV) at a given time t, i.e. e(t)=SP−PV. The controller uses e(t) multiplied by a proportional constant K to calculate a new controller output command to the conditioning elements. As the step based conditioning program describes uses on/off conditioning elements, the control method is based on time-proportional control, where the time the conditioning element is on during a cycle 200 is reduced, thereby reducing the power delivered. By proportioning the on time vs the off time of the conditioning element within a cycle, a proportional response is achieved. Another embodiment considers conditioning elements powered continuous actuators where the power delivered by a is controlled by regulating the current or the voltage.

As an example take a conditioner that has a temperature sensor and four conditioning elements that are controlled using a proportional control algorithm implemented by a control system 1115, that is running a conditioning program made up of multi-steps and corresponding cycles 200. At the start of the conditioning process, the conditioner step 1 is activated for 5 min with a target temperature to 200 degrees using four conditioning elements: broil, convection, bake microwave and broil, per cycle 200 as defined in FIG. 3. In this case, broil is set to 40% power, convection is set to 60% power, microwave is set to 100% power and bake is set 60% power. The proportional band of the time-proportional control used by the controller can be set at the same level for all conditioner elements, or it may vary depending on the type of conditioning element. For instance, the proportional band for the broil with a 1500 W power can be wider than the convection with 600 W of power, as the broil has a larger probability to overshoot as it not only has more power but also has the capability to store more energy (residual heat) which will dissipate even after the broil is turned off.

Assuming that the proportional band 1500 is set to 20 degrees and the target temperature for step 1 is 220 degrees for all conditioning elements, then the cycle of step 1 in the conditioning program will remain unchanged as the temperature increases from ambient temperature to 200 degrees. Once the temperature reaches 200, inside the control band, the time based proportional controller is activated. In this band, the power of the conditioning elements decreases in proportion to the error or deviation from the target temperature. For instance, when the temperature reaches 205 degrees, the cycle 200 will change so that the time on of every element is reduced by 75%. In this case the cycle 200 will be redefined where broil is set to 30%, convection to 45%, microwave is set to 75% and bake is set to 45%. Likewise, when the temperature reaches 210 degrees, the cycle 200 is redefined as having 20% broil, 30% convection, 50% microwave and bake to 30%. As the temperature approaches the target temperature, the time proportional control continuously adapts the cycle, until it reaches the target temperature of 220 degrees. Above 220 degrees all conditioning elements are off on subsequent cycles.

Another example illustrates the case where the proportional controller has different implementations according the type and power of conditioning elements and/or the attribute of either the nutritional substance or the conditioner. In the case where the power of the conditioning elements is significantly different, every conditioning element may require a different proportional band, in order to avoid overshooting and undershooting of the attribute to be measured. For instance, the high power of the broil requires a larger proportional band, as a unit change of the output will have more impact on the attribute than the convection element with one third the power, as it is in the case of the cavity temperature of the conditioner. Therefore, the broil element providing 1500 W of output power may require a proportional band of 20 degrees, whereas the convection providing an output of 500 W may require a smaller proportional band, which can be 5 degrees. If the cycle is defined as described in FIG. 3 and the target temperature is 200 degrees for a given step, the conditioner controller will proportionally decrease the time the broil is on between 180 degrees and 200 degrees, whereas the convection power will not be affected as long as the temperature is below 195 degrees. Assuming that the temperature is 190 degrees, the broil power will decrease to 20%, whereas the convection power will remain constant at 60%. Once the temperature reaches say 197.5 degree, the broil power will be 5%, whereas the convection will be 30%.

In the case where certain conditioning elements do not affect directly the control attribute or process variable, the proportional controller will act only on the conditioning elements that directly affect the process variable. The microwave does not impact directly the cavity temperature, or its effects are insignificant compared to the impact of other conditioning elements such as broil or bake. Hence, the proportional controller in a step within a conditioning program where the target variable is cavity temperature will control the power of the conditioning elements such as broil, bake and/or convection while leaving the microwave power unaffected.

Some steps within a conditioning program may require meeting two target process variables, such as cavity temperature measured by a thermistor and temperature of the nutritional substance measured by a food probe, before advancing to a subsequent step. In this case, the control band for microwave will be based on the nutritional substance temperature, whereas the control band for bake, broil and/or convection is determined by the temperature of the conditioner cavity. The same analogy can be applied to relative humidity. As the cavity reaches a certain level of target humidity, the power of the microwave is proportionally decreased based on the proportional, whereas the power of the conditioning elements such as broil, bake and/or convection are not affected by the relative humidity, but rather the cavity temperature, for example.

Other process variables such as aromas and color released by the nutritional substance can be affected by the conditioning process due to specific conditioning elements, such as the broil or bake. In the case of aromas, for instance, as soon as the chemical sensors or electronic noses reach the lower limit of the proportional band, the proportional controller starts decreasing the power to the specific heating elements, in this case the bake. Likewise, if the color meter senses that the color surface of the nutritional surface has reached the lower limit of the proportional band for browning, the controller proportional reduces the power to the broil. Once the target surface color has been achieved, the controller turns off the broil. Given the nature of process variables such as color and weight, once a limit has been achieved, it cannot be surpassed, as the change is not reversible. Thus, it is important for this variables to avoid overshooting, and this is where the proportional derivate controller implementation can be effectively implemented.

In some examples, the control system may implement a derivative control 1530 that minimizes overshoot by adjusting the proportional band based on the rate of temperature increase. For instance, the derivative control may determine the rate of the measured temperature 1510 increase, and adjust the proportional band 1550. The adjustment to the proportional band 1550 may be a translation, could be widening the range, or could be changing the formula for adjusting the conditioning power. In some examples, the change in conditioning element 1150 power output is directly proportional to the rate of change in the temperature. The degree of derivative control 1530 is expressed in the derivative time and should be adjustable in seconds. The proportional derivative controller can be implemented for, but not limited to, surface color of the nutritional substance, aromas released in the cavity by the nutritional substance, relative humidity in the cavity, weight of the nutritional substance,

Proper adjustment of the proportional band 1550 results in smooth control, however, the actual temperature seldom stabilizes exactly on the target temperature 900, and typically settles within some deviation called the offset 1560. In some examples, an integral control 1570 automatically compensates for the steady state offset 1560 inherent with a proportional controller.

For instance, an integral control 1570 may adjust the proportional band 1550 up or down depending on the offset 1560, to move the offset closest to zero. The integral time may be an adjustable parameter and can determine how fast the proportional band will moved by the integral control 1570.

Additionally, an anti-reset-windup 1590 control may inhibit the integral control 1570 until the measured temperature 1510 is within the proportional band 1550 to reduce overshoot on start-up. Integral control 1570 may be inhibited to prevent the integral control 1570 from adjusting the proportional band 1550 during both start-up and large target temperature 900 changes.

### Feed Forward Temperature Control

In some examples, the system may utilize a control system that utilizes feed forward temperature control rather than only feedback control. A feed forward temperature control may identify certain events that are predicted to drop the temperature (other than sensing a temperature drop) and adjust the conditioning elements accordingly.

This is in contrast to a conventional feedback mechanism that would not adjust the conditioning element 1150 power until the temperature sensors 1120 sensed a decrease in temperature. For instance, in a convention conditioner 1100, after the door is opened, the temperature sensor 1120 would sense the decrease in temperature after 20 or 30 seconds and increase the power to the conditioning elements 1150. However, in a feed forward mechanism, the system may sense the door opening and preemptively turn on the conditioning elements 1150 to accommodate the predicted drop in temperature either while the door was open or after the door closed, or both, subject to safety controls and protocols.

In one example, the system may include an conditioner 1100 with a door, and an entry sensor 1120 in the door. The entry sensor 1120 may detect when the door has opened, and the amount of time the door remained open. This door open event and the duration of time associated with it could be identified as an event that would result in a predictable drop in the measured temperature 1510. Accordingly, in response to the prediction and identified event, the control system may be able to determine corrective action for compensating for the predictive temperature drop. This may include energizing appropriate conditioning elements for an appropriate portion of percentage of cycles 200 based on the calculated corrective action either while the door was open or after the door closed or both. The corrective action might also include to add a new step, increase the time, or modify one or more subsequent steps.

In some examples, the corrective action will aim to restore the measured temperature 1510 to the target temperature 900 as soon as possible. In other examples, the corrective action will have the goal of restoring the temperature quickly but with a maximum activation percentage of the conditioning elements based on the nutritional substance and recipe so as not to burn or overly condition the outside portions.

In some examples, various parameters will be utilized to determine the corrective action and the predicted progression of temperature. For instance, the change in temperature over time or ΔT/Δt will be related to various factors including: (1) ambient and current conditioner air temperature, (2) heat elements utilized, (3) percentage on time of heat elements for each cycle 200, (4) thermal load in the conditioner, and (5) others.

In other examples, the system may calculate the power to maintain a target temperature 1510. For instance, the power to maintain may be based on the (1) measured temperature 1510, (2) heat elements utilized, (3) thermal load in the conditioner, and (4) others. Accordingly, these may be modified after leaning for specific nutritional substances and a specific conditioner.

### Heuristic Control Mode

Although, each of the conditioner systems may include default algorithms or parameters to control temperature. However, each conditioner 1100 will be subject to variations inherent in manufacturing as well as operational variations due to current environmental conditions. For example, conditioning element 1150 or conditioner insulation tolerances change the amount of power available to achieve or maintain a target conditioner temperature 900. Additionally, the current operational room temperature, humidity, power line conditions, altitude, and other factors change the amount of power required to reach or maintain target temperatures 900.

Therefore, it is useful for an conditioner 1100 or control system to use its actual ‘in-situ’ measured temperature 1510 to adjust the default feed-forward control parameters, thus learning and optimizing its own performance. For instance, in response to certain events, adjustments may be made to the amount of percentage of time that conditioning elements 1150 are activated for the cycle 200 of the given step based on experience for that conditioner. For instance, for each conditioning element 1150 and combination of conditioning elements 1150, the conditioner may develop its own ΔT/Δt curves, tables or formulas that describe the change in temperature based on the amount of power and loads while the conditioner is closed.

Additionally, the anticipated drop in measured temperature 1510 from, for example, a door open even may be adjusted. For instance, from a given starting measured temperature 1510, ambient temperature, and amount of time of door open, measured drops in temperature may be recorded, and the corrective action procedures may be adjusted.

### Pulse Width Modulation Control Using Solid State Relays

In order to implement the control of the temperature using conditioning elements 1150 as described herein, the system may utilize pulse width modulation (“PWM”) control using solid state relays. To implement PMW control, solid state relays may be utilized for fast, efficient switching, and to provide for low power loss when controlling high power heater loads. Additionally, solid state relays will avoid generation of electromagnetic noise, and have good wear life as they do not contain moving parts nor switching contacts that will physically wear out. SSRs are not very different in operation from mechanical relays that have movable contacts. SSRs, however, employ semiconductor switching elements, such as thyristors, triacs, diodes, and transistors. Furthermore, SSRs employ optical semiconductors called photocouplers to isolate input and output signals. Photocouplers change electric signals into optical signals and relay the signals through space, thus fully isolating the input and output sections while relaying the signals at high speed. Thus, SSRs provide high-speed, high-frequency switching operations, while generating very little noise and do not have operation noise. On the other hand, mechanical relays commonly used in commercial conditioners should not have cycles of less than 20 sec in to avoid short term failures.

PWM is a method by which power supplied to electrical devices, especially to inertial loads such as motors or heaters, can be controlled. In order to be most effective, the PWM switching frequency has to be much higher than what would affect the load (the device that uses the power). Accordingly, the resultant waveform as perceived by the load must be as smooth as possible.

The main advantage of PWM is that power loss in the switching devices is very low. When a switch is off there is practically no current, and when it is on and power is being transferred to the load, there is almost no voltage drop across the switch. However, during the transitions between on and off states, both voltage and current are nonzero and thus power is dissipated in the switches.

FIGS. 16A-16B illustrate examples of asynchronous, ½ cycle PWM control. FIG. 16A illustrates an example that shows a heater cycle 200 that includes 100½ cycles of the PWM controller, which each half cycle equal to about ˜2 ms. Illustrated are conditioning elements 1150 that are categorized as grill on for 60% of the cycle 200 and bake on for 40% of the cycle 200. The switching regions are illustrated to demonstrate the ˜2 ms delay between switching conditioning elements 1150. The benefits associated with this approach include more uniform conditioning that reduces conditioning element 1150 failures due to thermal fatigue and a better conditioning control in order to consistently optimize the conditioning process.

FIG. 16B illustrates an example graph showing of a cycle 200 that includes a microwave conditioning element 1150 activated during the cycle. For instance, 60% of the time of the cycle 200 includes a microwave conditioning element 1150 activated. The remaining 40% of the cycle is allocated to other conditioning elements 1150, for example conditioning elements 1150 categorized as grill 24% and bake 16%. Both of these examples are implemented using pulse width modulation control but may be implemented using other methods.

### Conditioner System

FIG. 11 illustrates an example conditioner system that may be utilized to implement the cycle based programs disclosed herein. The conditioner may include an conditioner 1100, with a control system 1115 that can turn on and off various conditioning elements 1150. The conditioning elements may be associated in various combinations that may execute the following functions: (1) broil 1150 (conditioning from above), (2) bake 1150 (conditioning from below), (3) convection 1150 (conditioning using a fan to circulate) (4) microwave 2250 and (6) others. The conditioner control system 1115 may execute a conditioning program 1180 built on the cycles 200 disclosed herein.

The conditioner 1100 and control module 1120 may include various sensors 1120. The sensors 1120 can be one or several temperature sensors 1120 including, convectional thermistors that detect the temperature inside the conditioner cavity, infrared sensors that detect the surface temperature of the nutritional substance, or temperature probes that detect the internal temperature. The sensors 1120 also can include weight sensors (e.g. scales inside the conditioner, on top, and/or the feet of the conditioner 1100 or the control module 1125), chemical sensors (e.g. electronic nose inside the cavity or connected to an air extractor inside the cavity that sends air sample of the cavity to electronic nose), relative humidity sensors (inside the cavity or connected to air extractor system inside the cavity that sends air sample of the cavity to the relative humidity sensor), spectral sensors (in close proximity to the external surface of the nutritional substance or as part of probe that penetrates the interior of the nutritional substance, connected to the sensor via fiber optic, for example), power sensors (to detect power consumed by the conditioner). or other types of sensors 1120 that may be utilized to provide feedback to modify or transition between steps as disclosed herein.

The conditioner 1100 may include a user interface 1130 to accept input from a user 1160 accordingly to various preferences. For instance, the user interface 1130 may input the nutritional substance type, preference for conditioning program, or preferences for ΔN. The conditioner 1100 may also include various scanners, such as barcode, QR code, RFID, optical or spectral data (not illustrated) or other features to identify nutritional substance items or packaging.

In some examples, the conditioner 1100 will communicate with a control module 1120 with its own control system 1115 and potentially user interface 1130. The control module may provide executable instructions to the conditioner 1100 after customizing a program for a particular piece of nutritional substance and for a particular conditioner 1100. Accordingly, in these examples, the control module may be able to be interchanged with different conditioners 1100 as long as the conditioning program can be adapted to condition the specific nutritional substance in a specific conditioner 1100. Accordingly, the control module 1125 may accept user 1160 input from a user interface 1130, or may receive conditioning programs 1180 over a network 1105 from a server 1165 that are stored in a database 1175. Accordingly, the different conditioning elements 1150 and control systems 1115 of each conditioner 1110 may require a different format of a conditioning program 1180 to be sent and executed by the control system 1115 of a local conditioner 1100.

In other examples, the control system 1115 of a local conditioner 1100 may in fact compile and execute a cycle 200 and step based conditioning program 1180 as disclosed herein based on user input to its local user interface 1130. In other examples, a conditioner control system 1115 may communicate directly with the server 1165 over the network 1105 to retrieve or customize conditioning programs 1180. In some examples, the cycle type and length will be either determined by the server 1165, the control module 1125 or the conditioner 1100.

### Conditioner Process for Implementing and Customizing Programs

FIG. 12 is an example process of outputting a program 1180 to meet the instructions of the user 1160. For instance, in some examples the system at some portion will receive instructions for a step 1200. In this example, the instructions may include the desired conditioning elements 1150 and the relative power required for each step. This may be entered as percentages or as medium, high, low for each conditioning element. Then, the target 120 temperature and/or time, and/or weight, and/or composition, and/or aromas or other factors will be entered to tri Based on this, the system will generate a cycle 1205 that includes a timeline for the entire cycle, and which elements are turned on and off at each point in time during the cycle. Then, if the target entered is a time, the system may determine a fixed number of cycles 200 to run for that particular step. Otherwise, the system may generate a program 1280 that requires the conditioner 1100 to repeat the cycles within a step until the target temperature or other factors such as weight, composition and/or aroma levels 120 are reached.

This process must then be repeated for all of the steps 1210, and then a final conditioner program 1180 must be created by a control system 1115 that can be sent 1215 to the conditioner 1100 and/or saved 1220 in the conditioner's 1100 memory for execution. In this step, the control system 1115 of either the conditioner 1100, control module 1125 or server 1165 may translate the steps and cycles into an executable program that is specialized for a specific conditioner 1100. For instance, the conditioning program will need to be able to switch the various conditioning elements 1150 on and off at various times within the cycle, and potentially modify the program 1180 with feedback from sensors 1120 during and before conditioning.

FIG. 13 is an example of a process that a conditioner system uses to create an executable program 1180 and condition nutritional substances in a conditioner 1100 using that program 1180. First, the conditioner system may receive the identity of the nutritional substance 1300. In this step, the system may utilize various processes for identifying the nutritional substance, including UPC through a scan of bar code, QR code, RFID, or an optical image (camera, hyperspectral, etc.) and using computer/machine vision, receiving input from a user 1160, or other processes and systems.

Then, the system may receive a selection of a conditioning program 1305, which may include the program data 1180 itself. For instance, the user 1160 may input their selection 1305 through the user interface 1130, and this may include defining the conditioning elements 1150, time, and percentage of each conditioning element 1150 and transition factors or targets 120 for each step. Additionally or alternatively, the user may receive the conditioning program and select the finish of the nutritional substance.

Then, once these are defined or selected (e.g. by selecting pre-determined steps/cycles 200), the system may then receive data from any sensors 1120 that detected attributes of the nutritional substance that was identified. This may include temperature (internal or surface), weight, composition, shape or others as disclosed. This data may be utilized to modify the selected program cycles 200 or steps appropriately to customize the program to the nutritional substance 1315.

To obtain optimum conditioning results, the conditioning program, made up of steps and cycles 200 may be adapted based on the weight, shape, composition or starting temperature of the nutritional substance. In some examples, the first step may be shortened, lengthened or have different temperature targets depending on the starting temperature. In other examples, the more the nutritional substance weighs the longer steps that are heavier on microwave conditioning elements 1150. In some examples, weight data from the sensor 1120 will be utilized to proportionally decrease the time of each step, or certain steps. In other examples, the weight will be utilized to proportionally decrease the percentage time activation for each conditioning element 1150 in a cycle 200.

Then, once the program is finalized it must be sent to the conditioner 1100 control system 1115, in a form executable by the conditioner 1100 control system 1115. In some examples, the control module 1125 control system 1115 will control the conditioning elements 1150 of the conditioner 1100. In some examples, the sent program 1180 will include time based instructions (e.g. simple counters, etc.) that determine when to turn off and on the conditioning elements 1150 based on a repeating temporal cycle 200 for each step. Each cycle 200 may span a length of 10 seconds, 20 seconds, 30 seconds, or other suitable times.

Once the conditioning program 1180 data is in a form executable by the conditioner 1100 control system 1115, the user 1160 may indicate when to initiate the program 1180. Accordingly, once the user 1160 determines the conditioner 1100 is ready to initiate the program 1180, the user 1160 may indicate through the user interface 1130 the conditioner 1100 is ready to start conditioning.

Accordingly, the conditioner control system 1115 or other connected control system 1115 may initiate the program 1180 and begin conditioning the nutritional substance. In some examples, the control system 1115 will initiate execution of the first step in the program 1180. For instance, the control system 1115 may turn on the required conditioning elements at each point in the cycle, and the repeat the process turning the required conditioning elements off and on at a regular interval. In some examples, the cycles 200 will be translated into off a set amount of time to turn each conditioning element 1150 off and on for one step.

Additionally, the control system 1115 will then monitor the specified conditions for the transition target 1325 to be reached. At that point, the control system 1115 will transition to the second step 1330 in the program and use new cycle 200 logic for the conditioning elements 1150. As discussed, these transition conditions may be a time, temperature, weight, composition of nutritional substance and/ or feedback from other sensors 1120.

The process will be repeated until the program finishes 1335, and the system can finish the conditioning sequence and notify the user 1160. In some examples, the user 1160 may have options to view the nutritional substance and add additional time once it is finished.

Adapting Programs based on ΔN

FIG. 14 is a flow chart illustrating a process for adapting the program 1180 based on a ΔN value, which may be used to optimize or select a desired nutritional, organoleptic or aesthetic outcome. For instance, as in the flow chart above, the system will first receive the identity of the nutritional substance 1300, receive a selection of the program 1305, and receive data from sensor(s) 1120 that have detected attributes of the nutritional substance 1310.

### ΔN Definition

ΔN is a measure of the change in a value of a nutritional substance, knowledge of a prior value (or state) of a nutritional substance and the ΔN value will provide knowledge of the changed value (or state) of a nutritional substance, and can further provide the ability to estimate a change in value (or state) and provide relevant nutritional substance information to make relevant nutritional substance decisions. The ΔN value may be represented or displayed to a consumer but not excluding as a per unit weight (e.g., ΔN per ounce, or ΔN per gram) format or value, may be displayed as a graph showing the change of the in the nutritional substance over time or in various other formats that would demonstrate a change in a ΔN. For example, a consumer may be presented but not excluding with a graph showing the historical or prospective change in the nutritional, organoleptic and/or aesthetic values of the nutritional substance, over time, conditioning temperatures, or other choices or attributes. This presents a continuum to the consumer of how ΔN may change with the change in various factors including time and conditioning temperature.

The ΔN value may also represent a comparison between the gold standard or average for a nutritional substance, and a particular or actual nutritional substance a consumer is considering purchasing. Accordingly, the attributes of a particular nutritional substance can be compared to the expected or optimal attributes of that type or category of nutritional substance. This allows a consumer to make more informed choices about the nutritional value of a substance a consumer is contemplating purchasing, or make informed decisions about preparation of the nutritional substance. For example, ΔN may represent a difference in the vitamin C content between on optimal orange that is picked when ripe from the vine, and an actual orange that a consumer is considering purchasing. In this example, if the consumer's orange was picked from the vine early, it may have both different surface physical characteristics that may be detectable by the sensors and methods described herein, and different vitamin C content. A database as described herein may include information regarding the physical attributes of an orange and how those factors correlate to the vitamin C content and other nutritional information. Accordingly, the systems disclosed herein may be able to determine the difference in vitamin C between a specific orange and the average vitamin C in oranges or the optimal vitamin C of, for example, an orange just picked from the vine when ripe. Accordingly, ripeness of tomatoes, water content, vitamin content, and other nutritional, organoleptic and/or aesthetic values may be compared for a specific, actual item a consumer is considering purchasing to the average or gold standard for that item. Accordingly, a consumer may then discern whether that particular item is providing at least an average or optimal nutrient, organoleptic and/or aesthetic value.

These differences may be presented in absolute value, for instance the difference in vitamin C, as a per unit weight value, as a graph comparing the present item versus an average curve for that specific item, or may be presented as a difference in nutritional content per unit price. For example, certain oranges or farmer's market produce may claim to have higher nutritional content because they are fresher or were harvested from the vines/roots closer in time to when the fruit ripened, leading to a higher nutritional content. However, these fruits tend to be higher in price, and accordingly, the system may be utilized to determine whether higher priced fruits are actually worth the higher price, and the amount of nutritional value gained per dollar difference. Accordingly, consumers could make informed choices based on quantitative data about whether and how much more nutritious more expensive fruit may be actually worth to the consumer.

In other examples, ΔN may represent the difference between the nutritional content of different subtypes of a broader category of nutritional substance. For instance, wild caught salmon is claimed to have up to 10 times greater omega three content than farm raised salmon. Accordingly, the present system could compare the nutritional content of a specific farm raised salmon to different types of wild caught salmon to determine the difference or ΔN in the omega three values. As described herein, this difference may be presented as an absolute value based on weight, an omega three difference per dollar, a per unit weight difference, or a graph indicating difference points including, average, optimum, and the current value of the fish on the graph.

In addition to identifying the nutritional substance, the required program 1180, and any physical attributes of the nutritional substance, the control system may also receive user preferences 1405 for a ΔN associated with the nutritional substance. For instance, the user may first select a program 1305 and then simultaneously or at a different time select a preference for a ΔN that may include maximizing a certain or several nutrients in the nutritional substance. For instance, if the user 160 selects to maximize the nutritional content, the control system 1115 may identify optimal steps or cycles 200 that minimize the degradation of nutrients 1415, by selecting the shortest time period for the over cycle or certain cycles where certain conditioning element percentages may be increased to shorten the cycle.

Accordingly, through the use of the steps and the cycles 200, the ΔN may be optimized to a user's 1160 preferences 1415, including for instance maximizing or minimizing the ΔN. Accordingly, with the currently conditioner 1100 system is capable of tailoring the programs 1180 more precisely than before, given the number and variability of conditioning elements 1150 that may be implemented at any time during a program 1180.

### Computer & Hardware Implementation of Disclosure

It should initially be understood that the disclosure herein may be implemented with any type of hardware and/or software, and may be a pre-programmed general purpose computing device. For example, the system may be implemented using a server, a personal computer, a portable computer, a thin client, or any suitable device or devices. The disclosure and/or components thereof may be a single device at a single location, or multiple devices at a single, or multiple, locations that are connected together using any appropriate communication programs over any communication medium such as electric cable, fiber optic cable, or in a wireless manner.

It should also be noted that the disclosure is illustrated and discussed herein as having a plurality of modules which perform particular functions. It should be understood that these modules are merely schematically illustrated based on their function for clarity purposes only, and do not necessary represent specific hardware or software. In this regard, these modules may be hardware and/or software implemented to substantially perform the particular functions discussed. Moreover, the modules may be combined together within the disclosure, or divided into additional modules based on the particular function desired. Thus, the disclosure should not be construed to limit the present invention, but merely be understood to illustrate one example implementation thereof.

The computing system (e.g. “control system”) can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

Implementations of the subject matter and the operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a “control system” on data stored on one or more computer-readable storage devices or received from other sources.

The term “control system” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The control system can also include, in addition to hardware, code that creates an execution environment for the computer program in question, e.g., code that constitutes processor firmware, a program stack, a database management system, an operating system, a cross-platform runtime environment, a virtual machine, or a combination of one or more of them. The control system and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

The various methods and techniques described above provide a number of ways to carry out the invention. Of course, it is to be understood that not necessarily all objectives or advantages described can be achieved in accordance with any particular embodiment described herein. Thus, for example, those skilled in the art will recognize that the methods can be performed in a manner that achieves or optimizes one advantage or group of advantages as taught herein without necessarily achieving other objectives or advantages as taught or suggested herein. A variety of alternatives are mentioned herein. It is to be understood that some embodiments specifically include one, another, or several features, while others specifically exclude one, another, or several features, while still others mitigate a particular feature by inclusion of one, another, or several advantageous features.

Furthermore, the skilled artisan will recognize the applicability of various features from different embodiments. Similarly, the various elements, features and steps discussed above, as well as other known equivalents for each such element, feature or step, can be employed in various combinations by one of ordinary skill in this art to perform methods in accordance with the principles described herein. Among the various elements, features, and steps some will be specifically included and others specifically excluded in diverse embodiments.

Although the application has been disclosed in the context of certain embodiments and examples, it will be understood by those skilled in the art that the embodiments of the application extend beyond the specifically disclosed embodiments to other alternative embodiments and/or uses and modifications and equivalents thereof.

In some embodiments, the terms “a” and “an” and “the” and similar references used in the context of describing a particular embodiment of the application (especially in the context of certain of the following claims) can be construed to cover both the singular and the plural. The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (for example, “such as”) provided with respect to certain embodiments herein is intended merely to better illuminate the application and does not pose a limitation on the scope of the application otherwise claimed. No language in the specification should be construed as indicating any non-claimed element essential to the practice of the application.

Certain embodiments of this application are described herein. Variations on those embodiments will become apparent to those of ordinary skill in the art upon reading the foregoing description. It is contemplated that skilled artisans can employ such variations as appropriate, and the application can be practiced otherwise than specifically described herein. Accordingly, many embodiments of this application include all modifications and equivalents of the subject matter recited in the claims appended hereto as permitted by applicable law. Moreover, any combination of the above-described elements in all possible variations thereof is encompassed by the application unless otherwise indicated herein or otherwise clearly contradicted by context.

Particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results.

All patents, patent applications, publications of patent applications, and other material, such as articles, books, specifications, publications, documents, things, and/or the like, referenced herein are hereby incorporated herein by this reference in their entirety for all purposes, excepting any prosecution file history associated with same, any of same that is inconsistent with or in conflict with the present document, or any of same that may have a limiting affect as to the broadest scope of the claims now or later associated with the present document. By way of example, should there be any inconsistency or conflict between the description, definition, and/or the use of a term associated with any of the incorporated material and that associated with the present document, the description, definition, and/or the use of the term in the present document shall prevail.

In closing, it is to be understood that the embodiments of the application disclosed herein are illustrative of the principles of the embodiments of the application. Other modifications that can be employed can be within the scope of the application. Thus, by way of example, but not of limitation, alternative configurations of the embodiments of the application can be utilized in accordance with the teachings herein. Accordingly, embodiments of the present application are not limited to that precisely as shown and described.

We claim:

1. A conditioner for conditioning nutritional substance, the conditioner comprising:
at least two conditioning elements;
a memory containing machine readable medium comprising machine executable code having stored thereon instructions for performing a method of conditioning nutritional substance;
a control system coupled to the memory, the control system configured to execute the machine executable code to cause the control system to:
receive, at the control system, a conditioning program comprising instructions to activate at least one conditioning element at regular intervals during at least two steps, each step comprising a series of identical cycles wherein each of the at least one conditioning element is activated for a certain percentage of each of the series of identical cycles and wherein each series of identical cycles is different for at least two of the at least two steps;
execute the conditioning program and thereby activate the at least one conditioning element for the percentages required by each of the at least two steps; and
advance to a next step of the at least two steps, when a target is achieved for each of the at least two steps.

2. The conditioner of claim 1, wherein the target is time or temperature.

3. The conditioner of claim 1, wherein the target is at least one of: composition of the nutritional substance, surface color of the nutritional substance, weight of the nutritional substance, relative humidity inside a cavity of the conditioner, or aromas released by the nutritional substance inside the cavity of the conditioner.

4. The conditioner of claim 1, wherein the target is determined by data output from a spectral sensor, optical sensor, load cell, chemical sensor, or a relative humidity sensor.

5. The conditioner of claim 1, wherein control system is further configured to execute the machine executable code to cause the control system to maintain a target temperature for each step over a target time.

6. The conditioner of claim 1, wherein the at least two conditioning elements are controlled using pulse width modulation.

7. The conditioner of claim 6, wherein pulse width modulation is implemented using solid state relays.

8. The conditioner of claim 2, wherein the target temperature is at least one of: the temperature of the conditioner compartment, the surface of the nutritional substance, or the inside of the nutritional substance.

9. The conditioner of claim 8, wherein the temperature is determined by data output from a thermistor, an infrared sensor, or a temperature probe.

10. The conditioner of claim 1, wherein the at least two conditioning elements comprise a bake conditioning element, a broil conditioning element, a microwave conditioning element, a convection conditioning element and a grilling conditioning element.

11. The conditioner of claim 1, wherein the cycles include at least one of a: 1 second, 5 second, 10 second, 20 second, 30 second, 60 second, or 600 second cycle.

12. The conditioner of claim 1, wherein the conditioning program does not include a preheat step.

13. A method for conditioning nutritional substance using an conditioner, the method comprising:
receiving, by an conditioner, a conditioning program comprising instructions to activate and deactivate at least one conditioning element of the conditioner at regular intervals during at least two steps, each step comprising a series of identical cycles wherein each of the at least one conditioning elements are activated for a certain percentage of time of the series identical cycles and wherein each series of identical cycles has a different target time or temperature for at least two of the at least two steps;
executing the conditioning program and thereby activating the at least one conditioning element for the percentages of total cycle time required by each of the at least two steps; and
advancing to a next step in the at least two steps, when a target is achieved for each of the at least two steps.

14. The conditioner of claim 13, wherein the target is time or temperature.

15. The conditioner of claim 13, wherein the target is at least one of: composition of the nutritional substance, surface color of the nutritional substance, weight of the nutritional substance, relative humidity inside a cavity of the conditioner, or aromas released by the nutritional substance inside the cavity of the conditioner.

16. The conditioner of claim 13, wherein the target is determined by data output from a spectral sensor, optical sensor, load cell, chemical sensor, or a relative humidity sensor.

17. The method of claim 13 further comprising:
receiving data output from a sensor relating to physical attributes detected by the sensor of the nutritional substance; and
customizing the conditioning program based on the data.

18. The method of claim 17 wherein the sensor is a weight sensor and a time of at least one of the at least two steps is proportionally decreased based on a difference between a weight of the nutritional substance determined from the data and a baseline weight for a type of the nutritional substance.

19. The method of claim 17 wherein the sensor is a temperature sensor and a time of at least one of the at least two steps is proportionally decreased based on a difference between a temperature of the nutritional substance determined from the data and a baseline temperature for the type of nutritional substance.

20. The method of claim 17, wherein the method is executed upon the pressing of a preset button pressed by a consumer on a consumer interface of the conditioner.

21. The method of claim 13, wherein the conditioning program comprising instructions is stored locally on the conditioner or remotely on a database connected to a server.

22. A conditioner for conditioning nutritional substance, the conditioner comprising:
at least two conditioning elements;
a memory containing machine readable medium comprising machine executable code having stored thereon instructions for performing a method of conditioning nutritional sub stance;
a control system coupled to the memory, the control system configured to execute the machine executable code to cause the control system to:
receive, at the control system, a conditioning program comprising instructions to activate each of the at least two conditioning elements for a percentage of time during each of a series of repeated cycles in order to maintain a target temperature;
receive, at the control system, data output from a temperature sensor;
repeatedly process the data output from the temperature sensor in order to repeatedly determine a temperature; and
decrease the percentage of time at least one of the at least two conditioning elements is activated for each of the repeated series of cycles once the determined temperature rises above a first threshold; and
increase the percentage of time at least one of the at least two conditioning elements is activated for each of the repeated cycles once the determined temperature falls below a second threshold.

23. The conditioner of claim 22, wherein the percentage of time is proportionally increased and decreased based on the amount the determined temperature is above the first threshold or below the second threshold.

24. The conditioner of claim 23, wherein the first and second threshold are the same and are equal to the target temperature.

25. The conditioner of claim 24, wherein the percentage of time is only proportionally increased when the determined temperature is within a proportionality temperature range surrounding the target temperature.

26. The conditioner of claim 25, wherein the proportionality temperature range is adjusted based on an offset, wherein the offset is a determined deviation of the measured temperature from the target temperature.

27. The conditioner of claim 25, wherein the proportionality temperature range is adjusted based on a rate of measured temperature increase.

28. The conditioner of claim 27, wherein the proportionality temperature range is adjusted based on an offset if the measured temperature is within the proportionality temperature range.

29. A conditioner for conditioning nutritional substance, the conditioner comprising:
at least one conditioning elements;
a memory containing machine readable medium comprising machine executable code having stored thereon instructions for performing a method of conditioning nutritional sub stance;
a control system coupled to the memory, the control system configured to execute the machine executable code to cause the control system to:
receive, at the control system, a conditioning program comprising instructions to activate the at least two one element for a percentage of time during each of a series of repeated cycles in order to achieve a target temperature;
receive, at the control system, data output from a temperature sensor;
receive, at the control system, data output from a door sensor;
repeatedly process the data output from the temperature sensor in order to repeatedly determine a temperature;
monitor data output from a door sensor for a door open event, and determine a time associated with the door open event; and
increase the percentage of time the at least two conditioning elements is activated for each of the repeated cycles in response to the door open event.

30. The conditioner of claim 29, wherein the percentage increase is based on the time associated with the door open event and the difference between the target temperature and the determined temperature.

31. The conditioner of claim 30, wherein the percentage increase is based data recorded by the control system during previous door open events.
